(19) United States
(12) Patent Application Publication
(10) Pub. No.: US 2013/0124361 A1
(43) Pub. Date: May 16, 2013

(54) CONSUMER, RETAILER AND SUPPLIER COMPUTING SYSTEMS AND METHODS

(71) Applicant: Christopher Bryson, Toronto (CA)

(72) Inventor: Christopher Bryson, Toronto (CA)

(21) Appl. No.: 13/734,959

(22) Filed: Jan. 5, 2013

Related U.S. Application Data
(63) Continuation of application No. PCT/CA2011/000791, filed on Jul. 7, 2011.
(60) Provisional application No. 61/362,387, filed on Jul. 8, 2010.

(51) Int. Cl. G06Q 30/06

(52) U.S. Cl. CPC G06Q 30/0631
USPC 705/26.7

(57) ABSTRACT

A system and method for generating recommendations is disclosed. The system includes first and second client machines, a connection router connected to the first and second client machines, at least one database, and at least one server connected to the connection router and in communication with the at least one database. The method involves generating and providing a list of recommendations.

### PRIORITY CLAIM

The present specification is a continuation of PCT Patent Application No. PCT/CA2011/000791 filed Jul. 7, 2011 which claims priority from U.S. Provisional Patent Application 61/362,387 filed Jul. 8, 2010, from which priority is hereby claimed, the contents of both of which are incorporated herein by reference.

### FIELD

The present specification relates generally to computing devices and more specifically relates to integrated consumer, retailer and supplier computing systems and methods.

### BACKGROUND

Inventories and sales of goods are increasingly tracked by computer servers. Likewise computer clients are increasingly used.

Customer loyalty for large retailers has eroded over the years as a result of shifting retail focus, new competition such as Costco and Wal-Mart, changing consumer needs, and customer fragmentation. This has created a challenging environment for retailers and put marketing budgets under a microscope. One message to a mass audience is not optimal as typically in the case of grocery retail, 10% of shoppers account for 50% of dollars.

In an effort to compete more effectively, many retailers launched loyalty programs and increased their focus on price. But loyalty programs have become ubiquitous, and price is not a sustainable competitive differentiator in the face of competitors such as Wal-Mart. However, loyalty programs have yielded a second area of opportunity to compete more effectively—loyalty data. By pairing purchase information with customer identifiers such as age, postal code and sex, retailers have been able to create segmentation models. This approach has been dubbed “customer-centric marketing” and focuses on sending relevant messages, offers, and content at the right time, through the right channel, so as to engage customers and ultimately deliver a greater store experience. The end result drives customer loyalty.

Retailers have adopted customer centric retailing as it has been proven to deliver sustainable 5-7% top-line revenue increases, competitive differentiation, and ultimately increased customer loyalty. The analytics derived can also help to deliver more efficient operations.

Across retail verticals, more and more companies are looking to adapt this strategy; its practices require capabilities that have typically been outsourced by retailers. As a result, the loyalty analytics industry has emerged over the last 7 years, growing to what is now a $700 million annually industry, spread across only a small handful of players. The largest of these companies is Dunnhumby, with an estimated $450 million in sales; others include Emnos, LMG, EYC, and 5one. These firms provide analytics tools, consulting, and facilitate the overall strategy. It's a highly strategic relationship, often resulting in a significant number of the analytics company staff taking up offices at the retailer. As such, a partnership model is typically adopted, where revenues from the customer-centric strategy are split between the two. Kroger and Dunnhumby have gone one step further, selling millions of dollars of data to FMCG (fast moving customer goods) companies such as Procter & Gamble and Kraft. Kroger's CEO Dave Dillon admitted that the Dunnhumby partnership generates millions in revenue, with a total of 60 clients, 40% of which are Fortune 500 firms.

Kroger has seen same-store sales grow 5% on average for the past 12 quarters (ending Q3 2009), versus the 2.7% industry average. That compares with growth of less than 1% for Vons parent Safeway Inc. and a 1.2% decline for Supervalu Inc., parent company of Albertsons (excluding fuel sales for all three). Much of Kroger's recent success can be attributed to a tracking system that identifies how often shoppers visit the store and provides the company with detailed information about what they buy, Kroger Chief Executive David B. Dillon said in an interview.

Tesco, the leading UK grocer and also a Dunnhumby partner, leverages loyalty analytics and continues to outpace the market with YOY sales increases of close to 7%, with profits ahead by 10%. This growth is completely attributed to insights from their loyalty data.

Growth rates for loyalty analytics companies are a healthy 30+%/yr. Individual partnerships between these analytics companies and retailers can range in value from $15M to $200M (what Kroger's relationship with Dunnhumby is estimated to be worth). Profitability is considerable; each partnership delivers a minimum 20% net profit.

Based on a survey by the Promotion Marketing Association's 2009 2nd annual Shopper Marketing Study, there is indeed demand for these data systems and partnerships between retailers and suppliers. Over two thirds (68%) rated creating joint shopper-marketing programs is important to them; however, only 34% rated their current execution as excellent or very good, indicating that there is still a wealth of opportunity.

The smart phone market is currently undergoing a massive change, heralded by a new breed of cell phone. Although smart phones such as the Blackberry have had strong adoption for quite some time, smart phones released since 2008 are quite different. These devices support operating platforms for which any third party developer can create an “application”. And consumer access to these 3rd party applications is simple and often free; users can download them straight to their phone while on the go. As a result, adoption of these applications has been incredibly strong. All different mobile platforms—Apple's iPhone OS, Google's Android (a platform used by many different cell phone manufacturers), Palm's OS, Blackberry's OS, and Window's Mobile's OS—host “marketplaces” for end users to download free and paid applications created by third party developers.

Adoption of smart phones and their applications has been strong and continues to grow:
Smart phones accounted for 25% of total phone sales in North America in Q3 2009, up from 21% in Q3 of 2008.
According to a November 2009 survey by Forrester Research , 17% of Americans own a smart phone that can load a 3rd party application, up from 11% at the end of 2008.
Assuming an average phone recycle rate of 3 yrs, at this growth rate, over 50% of North Americans will own a smart phone by 2013 that supports 3rd party applications
Within its first year, Apple's App Store had over 1.5 billion application downloads (5.5M apps/day), reached within 9 months of deployment.
By September '09, 14 months after the App Store launch, more than 100K apps were available.
iPhone and iPod touch users download an average of about 30 apps/device. At the end of 2008, only 7% of iPhone users had never downloaded an application.

### SUMMARY

In accordance with an aspect of the invention, there is provided a system for generating recommendations. The system includes first and second client machines. The system further includes a connection router connected to the first and second client machines. Furthermore, the system includes at least one database for storing the product information associated with a plurality of products, account information associated with a first account profile, and account information associated with a second account profile. In addition, the system includes at least one server connected to the connection router and in communication with the at least one database. The at least one server is operably configured to receive the product information from the at least one database. Furthermore, the at least one server is operably configured to generate a plurality of weighted values for each product based on the product information. In addition, the at least one server is operably configured to receive the account information associated with the first account profile. Also, the at least one server is operably configured to select a set of products from the plurality of products based on the account information associated with the first account profile. The at least one server is further operably configured to receive at least one survey result from the second client machine. Furthermore, the at least one server is operably configured to assign a matching value to a product from the set of products wherein the matching value is based on the plurality of weighted values and the at least one survey result. In addition, the at least one server is operably configured to generate a subset of products wherein the matching value of each product in the subset of products falls within a first predetermined range of values. Additionally, the at least one server is operably configured to assign a similarity coefficient between the first account profile and the second account profile. Also, the at least one server is operably configured to receive at least one recommendation associated with the second account profile from the at least one database if the similarity coefficient is within a second predetermined range of values. Furthermore, the at least one server is operably configured to provide a list of recommendations to the first client machine. The list of recommendations includes the at least one recommendation associated with the second account if the similarity coefficient is within the second predetermined range of values. Furthermore, the list of recommendations includes the subset of products.

The at least one server may also be configured to identify conflicting products based on the account information and exclude the conflicting products from the set of products.

The at least one server may be operably configured to identify the conflicting products based on an objective metric.

The objective metric may be associated with a presence of an ingredient.

The at least one server may be operably configured to select the set of products from the plurality of products based on a purchase history of the first account profile.

The at least one server may be further configured to change the matching value based on input received from the first client machine, and store the changed matching value in the product information.

The first predetermined range may be open and greater than a matching threshold.

The second predetermined range may be open and greater than a similarity threshold.

The at least one server may be operably configured to assign a similarity coefficient by calculating a Jaccard similarity coefficient based on the account information of the first account profile and the account information of the second account profile.

In accordance with another aspect of the invention, there is provided a method for generating a recommendation at a server. The method involves receiving product information associated with a plurality of products, the product information being stored in at least one database. Furthermore, the method involves generating a plurality of weighted values for each product based on the product information. In addition, the method involves receiving account information associated with a first account profile stored in the at least one database. Also, the method involves selecting a set of products from the plurality of products based on the account information associated with a first account profile. Additionally, the method involves receiving at least one survey result from a client machine. The method further involves assigning a matching value to a product from the set of products wherein the matching value is based on the plurality of weighted values and the at least one survey result. Furthermore, method involves generating a subset of products wherein the matching value of each product in the subset of products falls within a first predetermined range of values. Also, the method involves assigning a similarity coefficient between the first account and a second account. The method also involves receiving at least one recommendation associated with the second account profile if the similarity coefficient is within a second predetermined range of values. Additionally, the method involves providing a list of recommendations. The list of recommendations includes the at least one recommendation associated with the second account if the similarity coefficient is within the second predetermined range of values, and the subset of products.

The method may further involve identifying conflicting products based on the account information, wherein the set of products excludes the conflicting products.

Identifying the conflicting products may involve identifying based on an objective metric.

The objective metric may be associated with a presence of an ingredient.

Selecting the set of products may involve selecting the set of products from the plurality of products based on a purchase history of the first account profile.

The method may further involve changing the matching value based on input received from the client machine, and storing the changed matching value in the product information.

The first predetermined range may be open and greater than a matching threshold.

The second predetermined range may be open and greater than a similarity threshold.

Assigning a similarity coefficient may involve calculating a Jaccard similarity coefficient based on the account information of the first account profile and account information of the second account profile.

### BRIEF DESCRIPTION OF THE DRAWINGS

FIG. 1 shows a schematic diagram of an embodiment of an integrated consumer, retailer and supplier computing system.

FIG. 2 shows a flowchart showing the method that can be carried out by the system of FIG. 1.

FIG. 3 shows a schematic diagram of another embodiment of an integrated consumer, retailer and supplier computing system.

FIG. 4 shows a schematic diagram of yet another embodiment of an integrated consumer, retailer and supplier computing system.

FIG. 5 shows a schematic diagram of a plurality of servers in accordance with an embodiment of an integrated consumer, retailer and supplier computing system.

FIG. 6 shows a schematic diagram of a plurality of servers in accordance with another embodiment of an integrated consumer, retailer and supplier computing system.

FIG. 7 shows a schematic diagram of a retailer domain in accordance with an embodiment of an integrated consumer, retailer and supplier computing system.

FIG. 8 shows a display generated on a graphical interface of a shopping list in accordance with an embodiment the client machine shown in FIG. 1.

FIG. 9 shows a display generated on a graphical interface of a coupon in accordance with an embodiment the client machine shown in FIG. 1.

FIG. 10 shows a display generated on a graphical interface of a filtered list of products in accordance with an embodiment the client machine shown in FIG. 1.

FIG. 11 shows the client machine shown in FIG. 1 with display generated on a graphical interface of a barcode being scanned in accordance with an embodiment.

FIG. 12 shows a display generated on a graphical interface of another coupon in accordance with another embodiment the client machine shown in FIG. 1.

FIG. 13 shows a display generated on a graphical interface of a representation of a credit card in accordance with an embodiment the client machine shown in FIG. 1.

FIG. 14 shows a display generated on a graphical interface of a product page in accordance with an embodiment the client machine shown in FIG. 1.

FIG. 15 shows displays generated on a graphical interface of two client machines of shopping lists in accordance with an embodiment.

FIG. 16 shows a display generated on a graphical interface of a personalized shopping list in accordance with another embodiment the client machine shown in FIG. 1.

FIG. 17 shows a display generated on a graphical interface of the total cost of a purchase made with loyalty points in accordance with an embodiment the client machine shown in FIG. 1.

FIG. 18 shows a display generated on a graphical interface of an account history in accordance with an embodiment the client machine shown in FIG. 1.

FIG. 19 shows a display generated on a graphical interface of a barcode in accordance with an embodiment the client machine shown in FIG. 1.

FIG. 20 shows a display generated on a graphical interface of an alert in accordance with an embodiment the client machine shown in FIG. 1.

FIG. 21 shows a schematic diagram of another embodiment of an integrated consumer, retailer and supplier computing system.

FIG. 22 shows a flowchart showing the steps in a method carried out by the system of FIG. 21.

### DETAILED DESCRIPTION

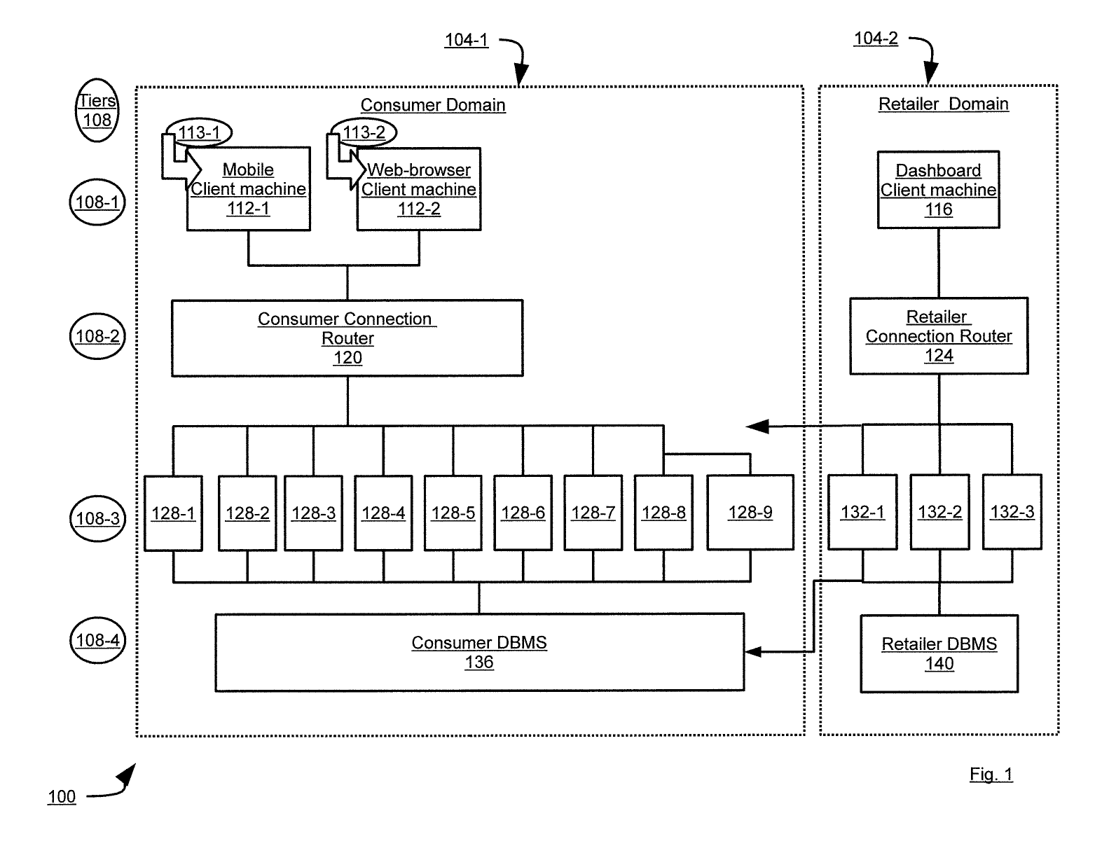

Referring now to FIG. 1, an integrated consumer, retailer and supplier computing system is indicated generally at 100. It is to be understood that the usage of the terms such as “consumer”, “retailer”, “supplier” are used as adjectives for illustrative convenience to assist the technologically skilled reader in conceptual understanding of different computing components used herein, but they are not to suggest that these computing components are somehow aware of the meaning of those adjectives in a technical sense. To further assist explanation for the skilled reader, system 100 is shown as logically divided into a consumer domain 104-1 and a retailer domain 104-2. (Generically, domain 104, and collectively, domains 104. This nomenclature is used elsewhere herein.)

The term consumer domain 104-1 contemplates a set of computing components and client machine accounts each uniquely associated with a plurality of individual consumers.

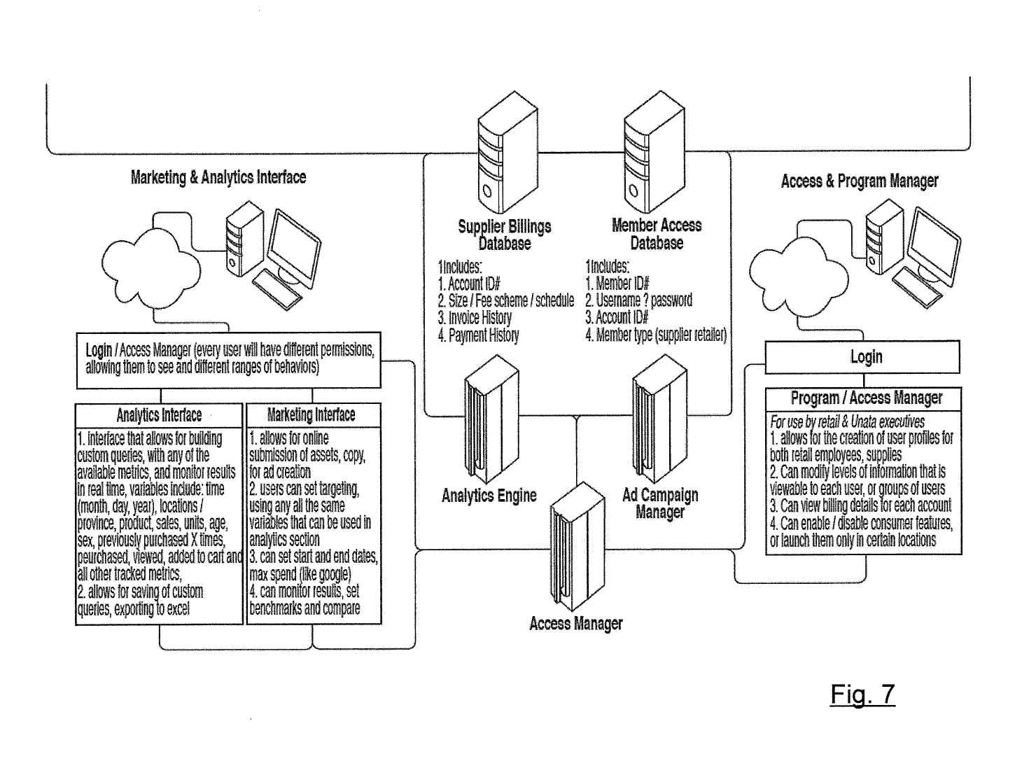

The term retailer domain 104-2 contemplates a set of computing components and a retailer account uniquely associated with a single retailer. However, it is to be understood that in variations, system 100 can be configured to include a plurality of retailer accounts each uniquely associated with a different retailers. In still further variations, system 100 can be configured to include one or more supplier accounts each uniquely associated with different suppliers. FIG. 7 provides a more detailed example of a retailer domain.

The term “consumer” thus refers to individuals or entities or enterprises that purchase items from retailers. The term “retailers” thus refers to entities or enterprises that sell products or services to consumers. The term “suppliers” thus refers to entities or enterprises that each provides different products or services to retailers for final sale to “consumers”.

Each domain 104 is also logically divided into a plurality of tiers 108.

Within consumer domain 104-1, tier 108-1 comprises a plurality of client machines 112, such as a mo bile client machine 112-1, or a web-browser client machine 112-2. While only two client machines 112 are shown, additional client machines with different computing environments are contemplated within the consumer domain 104-1. By way of specific example though, mobile client machine 112-1 can be based on a smart phone such as a BlackBerry™, Iphone™, Ipad™, Android™ device or the like running an “App” uniquely configured for that particular smart phone. As another specific example, web-browser client machine 112-2 can be based on a desktop computer or a laptop computer or another mobile client machine running a web browser. Other types of computing environments for various client machines 112 will now occur to those skilled in the art. While only two client machines 112 are shown in FIG. 1, additional client machines 112 are contemplated. Accordingly, each client machine 112 is thus generally configured to execute a client machine application 113 configured to utilize system 100 including, being configured to provide a graphical interface that can be used to utilize system 100 from the perspective of the consumer domain 104-1. (Thus, in the context of client machine 112-1, client machine application 113 can be the “App” discussed above, while in the context of client machine 112-2, client machine application 113-2 can be a web-browser. Other means of implementing client machine application 113 will now occur to those skilled in the art.) Each client machine 112 also includes a unique identifier making that client machine 112 uniquely addressable within system 100, such a unique identifier in turn being associated with an individual account and an individual account profile, as will be discussed further below. Client machines 112 can be configured to communicate via well-specified protocols using industry-standard encryption.

Within retailer domain 104-2, tier 108-1 comprises a dashboard client machine 116 that, much like client machines 112, can be also based on any desired computing environment, including a smart phone, desktop computer, laptop computer, or the like. Dashboard client machine 116 is thus generally configured to provide a graphical interface that can be used to configure system 100 from the perspective of the retailer domain 104-2. Dashboard client machine 116 also includes a unique identifier making that dashboard client machine 116 is also uniquely addressable within system 100. Dashboard client machine 116 can be configured to communicate via well-specified protocols using industry-standard encryption.

Within consumer domain 104-1, tier 108-2 comprises a consumer connection router 120 configured receive incoming requests from client machines 112 and direct them to the appropriate server 128 (discussed further below in relation to tier 108-3) within system 100, and to provide responses to such requests. In a present embodiment, consumer connection router 120 is configured to provide a consistent, database-agnostic application programming interface between tier 108-3 and tier 108-1 within the consumer domain 108.

Within retailer domain 104-2, retailer connection router 124 is configured to provide substantially the same function as consumer connection router 120 within the consumer domain 104-1, but is configured according to the additional services utilized from the perspective of the retailer domain 104-2.

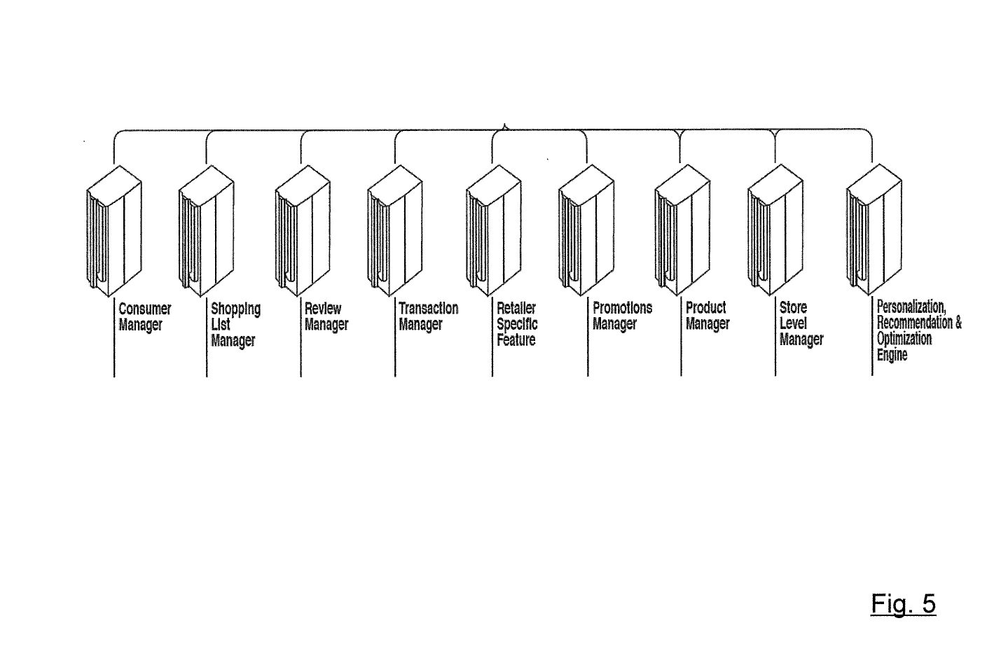

Within consumer domain 104-1, tier 108-3 comprises a plurality of servers 128. Note that while each server 128 is uniquely identified and shown as physically separate, it is to be understood that the particular way each server 128 is implemented is not particularly limited. Indeed, each server 128 is configured to execute its own service, as will be discussed further below, and in variations, such services can be configured to execute on a single server rather than the plurality of individual servers as shown in FIGS. 1 and 5. Other hardware configurations are also contemplated, including virtualized servers, mirrored servers or cloud-based servers.

Each server 128 is configured to correspond approximately to an individual database table, and is responsible for any process that creates, reads, updates or deletes anything from that table. Using this modular design, services for individual servers 128 can be optimized or re-written as needed. Below a specific discussion of each service executing on each individual server 128 is provided, but it is to be understood that other functions that can be implemented by each of those servers 128 is discussed elsewhere herein, and a review of this entire specification will lead to greater understanding of each server 128.

Server 128-1 is a consumer manager server 128-1. Consumer manager server 128-1 is configured to maintain individual accounts and profiles that are respectively accessible by client machine applications 113 executing on different client machines 112. Each account can include, for example, credentials necessary for accessing an account from a particular client machine application 113, and demographic information such as name, address, age, gender and the like. A profile can be uniquely associated for each account and can include, for example, a history of purchases, a history of browsed items, a history of shopping lists, a list of predefined preferences and the like. In variations, what is included in a profile may be stored on one or more of the other servers 128 using the account identifier as a unique index. Other examples of what can be included in a profile are discussed elsewhere herein. For purposes of explanation, it is assumed that client machine application 113-1 is associated with a first account and profile, while client machine application 113-2 is associated with a second account and profile. It is to be recognized that additional accounts and profiles can be provided for additional client machines, not shown. It is also to be recognized that system 100 contemplates that the same account may be accessed from different client machines 112, but for illustrative purposes it will be assumed in the discussion herein that there is a one-to-one relationship between each account and each client machine application 113.

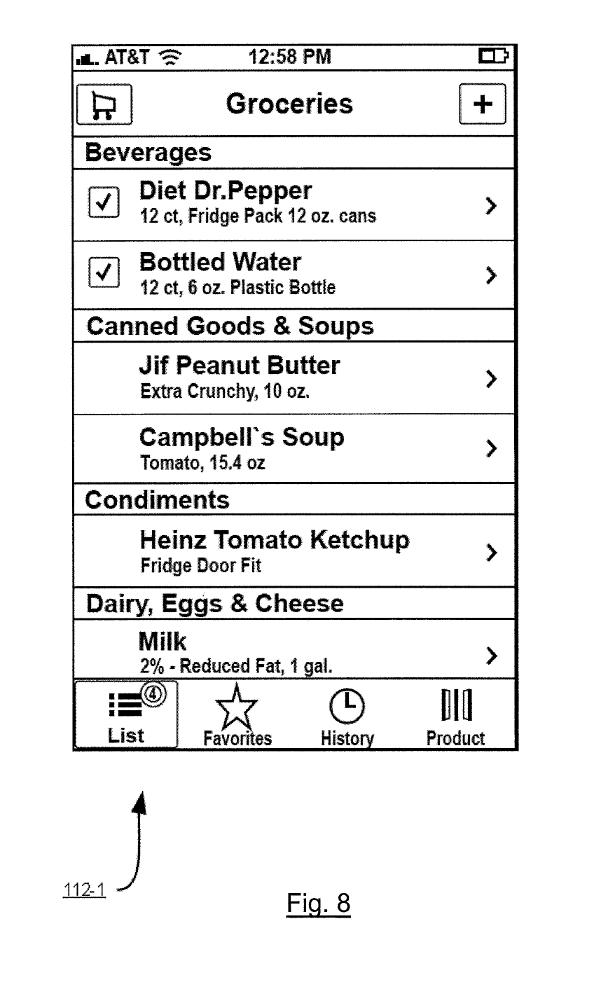

Server 128-2 is a shopping list manager server 128-2. Shopping list manager server 128-2 is configured to maintain, in relation to each account on consumer manager server 128-1, individual shopping lists. FIGS. 8, 15, and 16 show examples of graphical interfaces for displaying a shopping list managed by the shopping list manager server 128-2 in accordance with an embodiment of the invention. The graphical interface can be displayed on the screen of the client machine 112-1 displaying a shopping list.

Server 128-3 is a review manager server 128-3. Review manager server 128-3 is configured to maintain review data, such as ratings, textual, audio, video or pictorial data about subjective views relating different products, as received from certain client machines 112. Such review data and which are then aggregated and available for access from other client machines 112.

Server 128-4 is a transaction manager server 128-4. Transaction manager server 128-4 is configured to maintain and process purchase and loyalty transaction data. For example, as various items on a shopping list are accumulated, transaction manager can be configured to record subtotals and total purchase costs, and to manage any loyalty point accumulations or redemptions associated with such purchase. Transaction manager can also be configured to manage the actual purchase transaction at the time of checkout, putting an appropriate charge onto a consumer financial account such as a credit card. Transaction manager can also be configured to manage actual accumulation or redemption of loyalty points at the time of checkout, deducting or adding a certain amount of loyalty points in association with the transaction.

Server 128-5 is a retailer specific server 128-5. Retailer specific server 128-5 is optional as its functionality can be effected by other servers 128, but if provided can be uniquely associated with the infrastructure within retailer domain 104-2, and thus it will be understood that in variations, where multiple retailer domains are provided for different retailers then additional retailer specific servers 128-5 can be provided for each retailer. By the same token, where one or more supplier domains are provided for different suppliers, then supplier specific servers can also be provided which are modeled after retailer specific servers 128-5. A retailer specific server 128-5 can thus be configured for any specific aspects unique to a retailer associated with retailer domain 104-2. For example, assume that the retailer associated with retailer domain 104-2 is a building supply enterprise that rents tools or machinery. In that event retailer specific server 128-5 can be configured to ultimately provide a graphical interface to various client machines 112 to administer rentals, and then interface with other servers 128 to seamless integrate the rental functionality with the functionality of other servers 128. As another example, assume that the retailer associated with retailer domain 104-2 has a mail order service, in which case retailer specific server 128-5 can be configured to provide a graphical interface that manages shipping requests in a manner that seamless integrates the mail order functionality with the functionality of other servers 128.

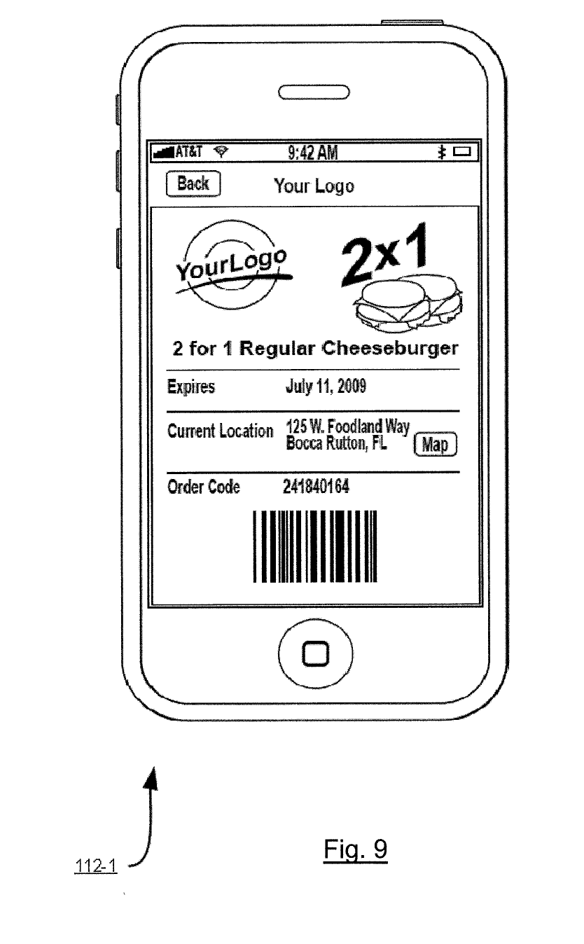

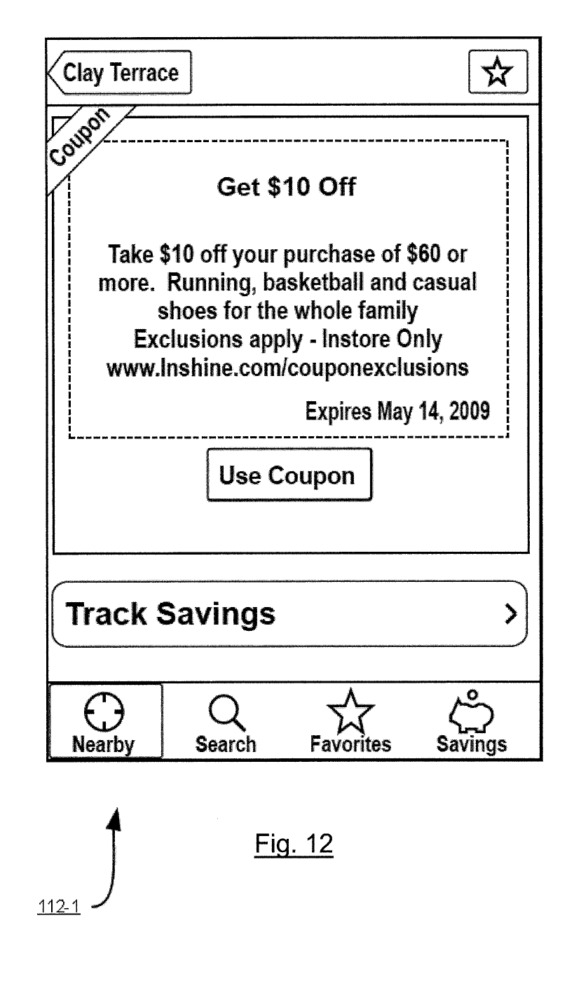

Server 128-6 is a promotion manager server 128-6. Promotion manager server 128-6 is configured to manage advertising streams or virtual coupons or the like that may be generated on a graphical interface of a given client machine 112-1 such as in the example shown in FIG. 9 and FIG. 12.

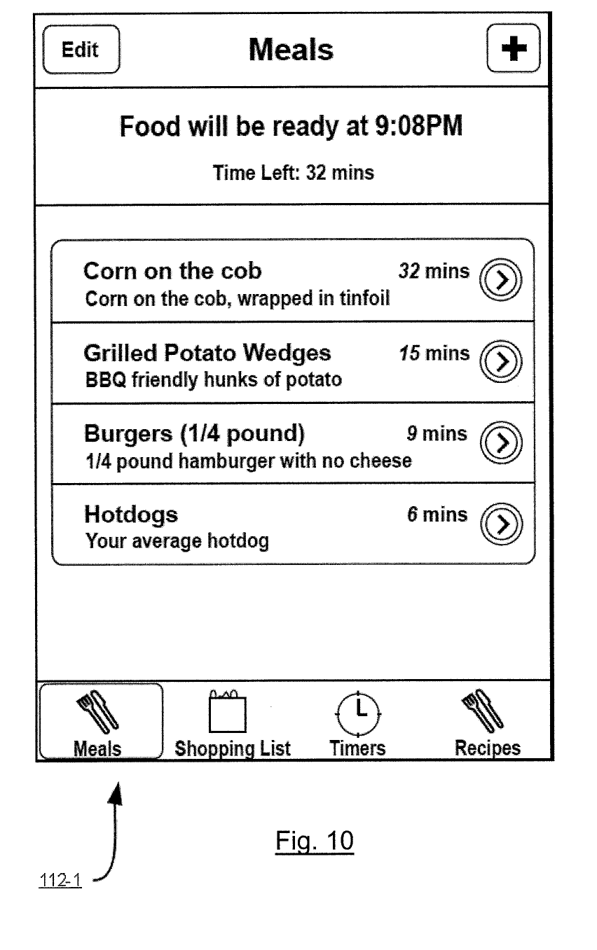

Server 128-7 is a product manager server 128-7. Product manager server 128-7 is configured to manage inventories of products that are available from the retailer associated with retailer domain 104-2. Such inventories are then accessible by other servers 128 to define what products are actually generated on a given graphical interface for a given client machine 112-1. In an embodiment of the invention, the product manager server may filter the products and generate only certain products based on a constraint. For example, FIG. 10 shows the output of a graphical interface where only products requiring less than a pre-determined amount of time to prepare are displayed.

Server 128-8 is a store manager server 128-8. Store manager server 128-8 is configured to manage inventories of products that are available from a particular store associated with a retailer associated with retailer domain 104-2. Such store-level inventories are then accessible by other servers 128 to define what products are actually generated on a given graphical interface for a given client machine 112, particularly where the client machine 112 has indicated a preference for a particular store. Store manager server 128-8 can also be configured to maintain locations for such products within a store, and to generate those locations on the graphical interface for a given client machine 112. For example, if bread is located in aisle five of a particular store, then that location can be generated on the specific client machine 112.

Server 128-9 is a recommendation engine server 128-9. Working in conjunction with other servers 128 and server 132, recommendation engine server 128-9 is generally configured to automatically provide a prioritization of products for a given account and, based on that prioritization, generate information about those products on a graphical interface of a given client machine 112 associated with that given account. Server 128-9 will be discussed in greater detail below.

Within retailer domain 104-2, tier 108-3 also comprises a plurality of servers 132. Note that while each server 132 is uniquely identified and shown as physically separate, it is to be understood that the particular way each server 132 is implemented is not particularly limited. Indeed, each server 132 is configured to execute its own service, as will be discussed further below, and in variations, such services can be configured to execute on a single server rather than the plurality of individual servers as shown in FIG. 1. Other hardware configurations are also contemplated, including virtualized servers, mirrored servers or cloud-based servers.

Each server 132 is configured to correspond approximately to an individual database table, and is responsible for any process that creates, reads, updates or deletes anything from that table. Each server 132 can also be configured to interact with, and update, each server 128. The converse is also true, in that each server 128 can also be configured to interact with, and update, each server 132. Again, using this modular design, services for individual servers 132 can be optimized or re-written as needed. Below a specific discussion of each service executing on each individual server 132 is provided, but it is to be understood that other functions that can be implemented by each of those servers 132 is discussed elsewhere herein, and a review of this entire specification will lead to greater understanding of each server 132.

Server 132-1 is an analytics engine server 132-1. Analytics engine server 132-1 can be configured with any desired set of algorithms or operations that search for trends or perform other data mining functions in relations to the computing processing actions within consumer domain 104-1 and elsewhere within retailer domain 104-2. The results from analytics engine server 132-1 can, if so configured, be returned to recommendation engine server 128-9 for use thereby.

Server 132-2 is an access manager server 132-2. Access manager server 132-2 is an administrative server, managing various administrative functions including credentials to administer system 100, and providing a configuration interface for various servers 128 or servers 132. Access manager server 132-2 can also be configured to manage, provision, or update individual accounts maintained on consumer manager server 128-1.

Server 132-3 is an advertising campaign server 132-3. Advertising campaign server 132-3 is configured to provide a unified graphical and programming interface directed to any particular promotions or individual or groups of products. Such an application interface then can be used to access data from other servers 128 or servers 132, and to globally propagate any updates or configurations to other servers 132 or servers 128. As a non-limiting illustrative example, if a particular product campaign includes temporarily placing a specific product in a display at the head of an aisle of a store, and also includes temporarily increasing loyalty points associated with that product, then using advertising campaign server 132-3, the temporary change in loyalty points can be propagated to the transaction manager server 128-4, and the temporary change in location can be propagated to the store manager server 128-8.

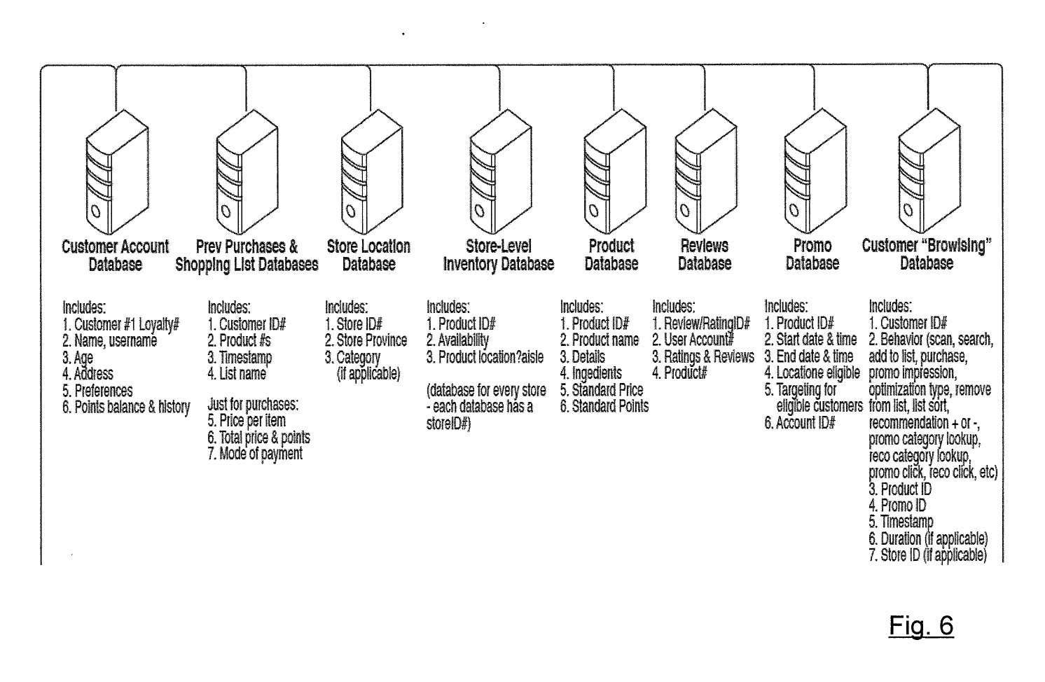

Within consumer domain 104-1, tier 108-4 comprises a consumer database management system (DBMS) 136 that manages all aspects of data of interest to each server 128. Within retailer domain 104-2, tier 108-4 comprises a retailer database management system (DBMS) 140 that manages all aspects of data of interest to each server 132. Consumer database management system 136 and retailer database management system 140 are, in a present embodiment, separated to increase security and to allow for the possibility of using different technologies for the consumer-facing Online Transaction Processing (OLTP) system and the predominantly Online Analytical Processing (OLAP) retailer-facing system. While not shown in FIG. 1, third party database systems would appear in this tier as well. For example, FIG. 6 shows an example of some of the databases that may be incorporated into the system 100.

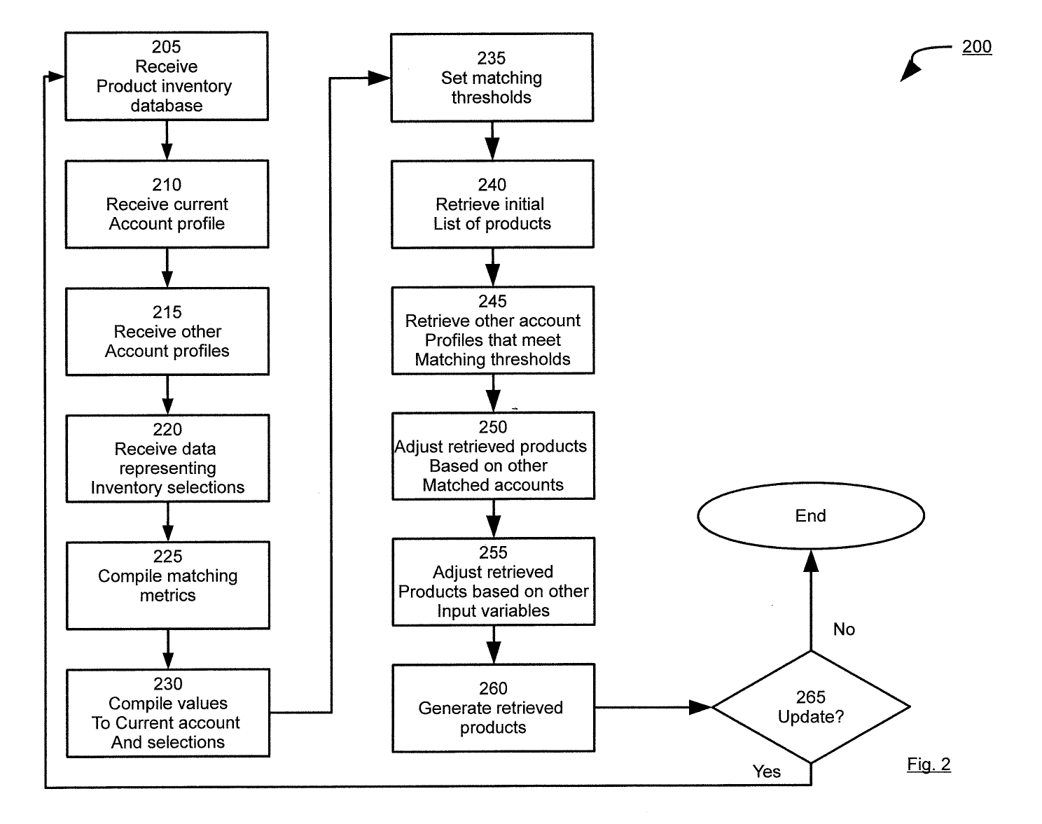

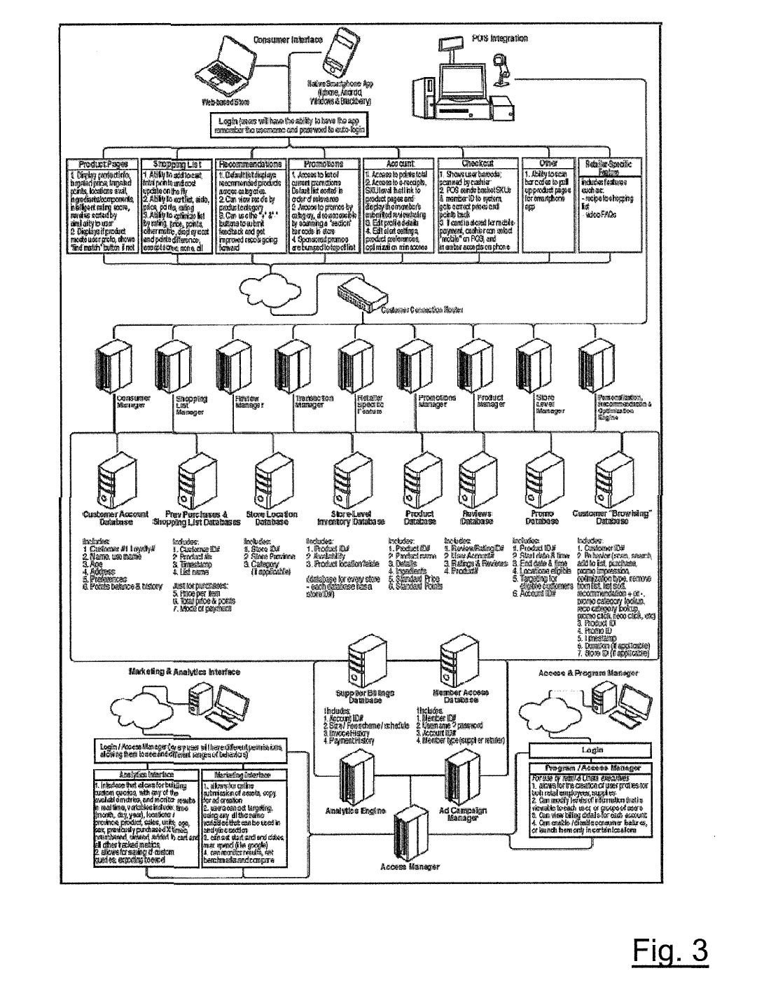

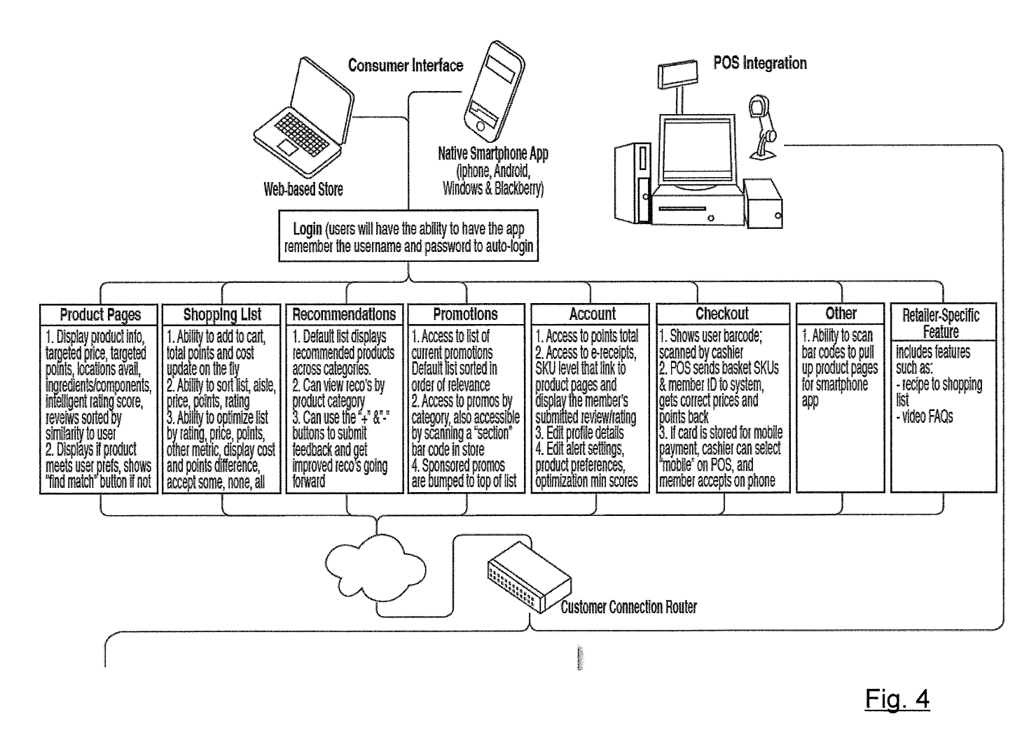

The various links between the components in system 100 (not labeled with reference characters), but can be implemented using any networking technology or topology, including wired or wireless, or local area network or wide area network, or via the Internet, or via any public data network or any private data network, or any combination thereof. Furthermore, the components need not be organized in the tiers described above. For example, other embodiments of the invention are shown in FIGS. 2, 3 and 4.

Various processes and methods can be effected using system 100, and its variants, according to the teachings of the entirety of this specification. One non-limiting specific example of a method that can be effected using system 100 is shown in the form of a flowchart in FIG. 2 and indicated generally as 200. Method 200 is a computer-based method for generating product recommendations. As noted above, method 200 can be implemented using system 100 or variants thereon. However, for purposes of explanation, method 200 will be described in relation to system 100. Note that while method 200 is shown as a sequence of blocks, those blocks need not necessarily be performed in the order shown, and indeed certain blocks may be performed in parallel with other blocks.

Block 205 comprises receiving a product inventory database. In system 100, block 205 can be effected by recommendation engine server 128-9, which can receive, (and by receive, it is contemplated that this can include merely having access to such a database through software programming interfaces), the entirety of a database that contains the complete product inventory of a retailer respective to retailer domain 104-2. Such a database can be accessed in a variety of ways, but in system 100, retailer DBMS 140 maintains the product inventory database contemplated by block 205. Access to retailer DBMS 140 from recommendation engine server 128-9 can be effected through a programming interface maintained by product manager server 128-7, or in variants product manager server 128-7 can be obviated or omitted, and the programming interface is maintained directly within recommendation engine server 128-9 and used to access retailer DBMS 140. In still further variations, where a given client machine application 113 executing on a given client machine 112 is localized to a particular store location (out of a plurality of store locations associated with retailer domain 104-2), then the product inventory database can be filtered, via an interface maintained in store manager server 128-7, according to the product inventory currently available at the particular store location.

Block 210 comprises receiving a current account profile. Block 210 thus begins to contemplate that method 200 is directed to a particular instance of a client machine application 113 on a particular client machine 112. As an illustrative example, further discussion of method 200 will assume that client machine application 113-1 is executing on client machine 112-1, but it is to be understood that this illustrative example teaches how method 200 can be scaled to a plurality of client machine applications 113 and client machines 112. Accordingly, block 210 receiving an account profile associated with client machine application 113-1, it being assumed that credentials have already been provided at client machine application 113-1. In system 100, the account profile associated with client machine application 113-1 can be retrieved by recommendation engine server 128-9 from consumer manager server 128-1. As noted above, various demographic information can be loaded from the profile. As a simplified, illustrative example, it will be assumed that the electronic data representing the demographic information “prefers organic foods” is associated with the account profile associated with client machine application 113-1. Such electronic data can be expressed in a number of ways, such as by having a bit field within the account profile that can be set to “zero” to indicate “no preference to organic food” or set to “one” to indicate “prefers organic foods”.

Block 215 comprises receiving other account profiles. In system 100, block 215 thus contemplates that the other account profiles can be retrieved by recommendation engine server 128-9 from consumer manager server 128-1. Since system 100 only shows two client machines 112, then in the retrieved other account profile would be the account profile associated with client machine application 113-2. The usage and analysis of such other account profiles will be discussed further below.

Block 220 comprises receiving data representing inventory selections. In relation to system 100, block 220 contemplates that client machine application 113-1 is utilized to receive potential inventory selections from the available inventory discussed above in relation to block 205. Such inventory selections can be received through a number of different channels, such as via a service hosted by the shopping list manager server 128-2 that can receive specific selections of products. The format of the inventory selections is not particularly limited, and can be on a granular level to specify specific products, such as “eggs”, “bread”, “milk”, and for purposes of continuing a specific illustrative example, it will be assumed that this specific product selection is also provided. However, it is to be understood that such selections can also be made indirectly, in the format of meals. For example, it is contemplated that the inventory selection can be in the form of “French toast”, which can then be automatically broken down into constituent recipe elements of “eggs”, “bread”, “milk” through a database look-up that associates “French toast” with “eggs”, “bread”, “milk”. It is also contemplated that a plurality of recipes can be maintained so that a meal selection could then point to a plurality of different constituent recipe elements, and further input can be provided to select a desired version of the recipe. All of the foregoing functionality can be incorporated into the shopping list manager server 128-2. These illustrative examples will now permit a person skilled in the art to consider other examples and more generally how data representing inventory selections can be received.

Block 225 comprises compiling matching variables. Matching variables generally contemplates set of fields that can be populated with numerical values and which are associated with different fields and records within the product inventory database received at block 205, the profile account information received at block 210, and block 215 and to the inventory selections received at block 220.

Block 230 comprises compiling values to the matching variables contemplated at block 225, based on the specific responses received at block 205, block 210, block 215 and block 220. Table I shows an illustrative, but non-limiting example continuing with the specific examples above, as to the result of performance of block 230.

TABLE I
Results of Example Performance of Block 230

| | Method Block | | | Variable |
|---|---|---|---|---|
| Index | Label | Variable Name | Variable Value | Meaning |
| 1 | 205 | {Product Description | 1 | 1 = In stock |
| | (Inventory | <Eggs><Johnson's Brand> | | 0 = Out of Stock |
| | Database) | <Organic>} | | |
| 2 | 205 | {Product | 0 | 1 = In stock |
| | (Inventory | Description<Eggs><Sally's | | 0 = Out of Stock |
| | Database) | Brand><Organic>} | | |
| 3 | 205 | {Product Description | 1 | 1 = In stock |
| | (Inventory | <Bread><Dave's Brand><Non- | | 0 = Out of Stock |
| | Database) | organic >} | | |
| 4 | 205 | {Product | 1 | 1 = In stock |
| | (Inventory | Description<Bread><Joe's | | 0 = Out of Stock |
| | Database) | Brand><Organic>} | | |
| 5 | 205 | {Product | 1 | 1 = In stock |
| | (Inventory | Description<Milk><Fred's | | 0 = Out of Stock |
| | Database) | Brand><Organic>} | | |
| 6 | 205 | {Product Description<Milk><Bill's | 1 | 1 = In stock |
| | (Inventory | Brand><Organic>} | | 0 = Out of Stock |
| | Database) | | | |
| 7 | 205 | . . . Additional Variables . . . | . . . Additional | . . . Additional |
| | (Inventory | | Values . . . | Meaning . . . |
| | Database) | | | |
| 8 | 210 | {Application Instance<113-1>} | 1 | Account holder |
| | (Current | {Preference<Organic Foods>} | | associated with |
| | Account | | | application |
| | Profile) | | | 113-1 |
| | | | | (the current |
| | | | | account) |
| | | | | prefers organic |
| | | | | foods |
| 9 | 210 | {Application Instance<113-1>} | . . . Additional | . . . Additional |
| | (Current | . . . Additional Variables . . . | Values . . . | Meaning . . . |
| | Account | | | |
| | Profile) | | | |
| 10 | 215 | {Application Instance<113-2>} | 1 | Account holder |
| | (Other | {Preference<Organic Foods>} | | associated with |
| | Account | | | application 113- |
| | Profiles) | | | 2 |
| | | | | (other account) |
| | | | | prefers organic |
| | | | | foods |
| 11 | 215 | {Application Instance<113-2>} | 1 | 1 = Bill's Organic |
| | (Other | {Previous Selection<Milk><Bill's | | milk was |
| | Account | Brand><Organic>} | | previously |
| | Profiles) | | | purchased by |
| | | | | the account |
| | | | | holder of |
| | | | | Application 113- |
| | | | | 2 |
| | | | | 0 = Bill's Organic |
| | | | | milk was not |
| | | | | previously |
| | | | | purchased by |
| | | | | the account |
| | | | | holder of |
| | | | | Application 113- |
| | | | | 2 |
| 12 | 215 | {Application Instance<113-2>} | 1 = | 1 = Bill's Organic |
| | (Other | {Previous Rating<Milk><Bill's | Bill's Organic | milk was rated |
| | Account | Brand><Organic>} | milk was rated | positively by the |
| | Profiles) | | positively | account holder |
| | | | | of Application |
| | | | | 113-2 |
| | | | | 0 = Bill's Organic |
| | | | | milk was not |
| | | | | rated positively |
| | | | | by the account |
| | | | | holder of |
| | | | | Application 113- |
| | | | | 2 |
| 13 | 215 | {Application Instance<113-n>} | . . . Additional | . . . Additional |
| | (Other | . . . Additional Variables . . . | Values . . . | Meaning . . . |
| | Account | | | |
| | Profiles) | | | |
| 14 | 220 | {Product Selection} | Eggs | Eggs Selected |
| | (Inventory | | | |
| | Selection from | | | |
| | Current | | | |
| | Account) | | | |
| 15 | 220 | {Product Selection} | Milk | Milk Selected |
| | (Inventory | | | |
| | Selection from | | | |
| | Current | | | |
| | Account) | | | |
| 16 | 220 | {Product Selection} | Bread | Bread Selected |
| | (Inventory | | | |
| | Selection from | | | |
| | Current | | | |
| | Account) | | | |

Block 235 comprises setting matching thresholds. The way the matching thresholds are set can vary according to how the matching metrics are compiled at block 225 and the values are compiled at block 230. In Table I, for example, binary values provided in the form of “zeros” and “ones”, and thus the matching thresholds can be set to require a “one” to match a “one” in order for a match to be satisfied. For illustrative purposes, further discussion will assume such a “one” to “one” match is required. However, in variations, where scalar, vector or other multi-dimensional metrics and values are employed, then likewise the matching thresholds can be set accordingly.

Block 240 comprises retrieving an initial list of products. The initial list of products can be based on the current account profile from block 210, inventory selections from block 220, and the matching thresholds from block 235. Continuing with the example in Table I, Index Row 8 of Table I shows the current account holder prefers organic foods, and Index Rows 14, 15 and 16 show inventory selections of Eggs, Bread and Milk respectively, and the matching thresholds from block 235 show a one-to-one matching required. Based on Rows 8, 14, 15 and 16, an initial list of products can be retrieved from Index Rows 1 through 6. More specifically:

In Relation to the “Eggs” Selection from Block 220

A. Index Row 1 is included in the retrieved list to suggest Johnson's Brand Organic Eggs to satisfy the Eggs Selection.

B. Index Row 2 is excluded from the retrieved list since Sally's Brand of Organic Eggs are not in stock.

In Relation to “Bread” Selection from Block 220:

A. Index Row 3 is excluded from the retrieved list since Dave's Brand of Bread is not organic.

B. Index Row 4 is included in the retrieved list to suggest Joes' Brand of Organic Bread to satisfy the Eggs Selection.

In Relation to “Milk” Selection from Block 220:

A. Index Row 5 is initially included in the retrieved list to suggest Fred's Brand of Organic Milk to satisfy the Milk selection.

B. Index Row 6 is currently excluded from the retrieved list since the Milk selection is already satisfied by the inclusion of Index Row 5, even though the Bill's Brand of Organic Milk otherwise matches.

Table II thus shows an example result of performance of Block 240 based on the contents of Table I

TABLE II
Results of Example Performance of Block 240
Initial Recommended Shopping List

| Index | Item | Recommended Product | Origin |
|---|---|---|---|
| 1 | Eggs | {Product Description | Index Row 1 of |
| | | <Eggs><Johnson's Brand> | Table I |
| | | <Organic>} | |
| 2 | Bread | {Product | Index Row 4 of |
| | | Description<Bread><Joe's | Table 1 |
| | | Brand><Organic>} | |
| 3 | Milk | {Product | Index Row 5 of |
| | | Description<Milk><Fred's | Table 1 |
| | | Brand><Organic>} | |

Block 245 comprises retrieving other account profiles that meet matching thresholds from block 235. Block 245 thus comprises comparing the current account profile from block 210 with the other account profiles from block 215 and then filtering so that only certain other account profiles that have common characteristics (i.e. that meet or exceed the matching thresholds) with the current account profile are preserved. Continuing with the example in Table I, an examination of Index Row 8 with Index Row 10 reveals that a match can be found between the current account holder (i.e., the account holder associated with application 113-1) and the account holder associated with application 113-2, in that both account holders have a preference for organic foods.

Block 250 comprises adjusting the retrieved list of products based on other matched accounts. Block 250 thus comprises comparing the results of block 240 with any further data that may be found from the results retrieved from block 245 and making adjustments to the list in from block 240 if other matching thresholds are met. Continuing with the examples from Table I and Table II, it can be noted that the account holder associated with application 113-2, who has been deemed similar to the current account holder, has previously provided a positive rating after having previously purchased Bill's Brand Organic Milk, as particularized in Index Rows 11 and 12 of Table I. It can also be noted that from Table II, currently Fred's Brand Organic Milk is being suggested. Accordingly, the list from Table II can be adjusted to reflect the data in Rows 11 and 12 of Table I. Table III shows a adjusted version of Table II, whereby the Index Row 3 is changed to show Bill's Brand of Organic Milk rather than Fred's Brand of Organic Milk.

TABLE III
Results of Example Performance of Block 250
Adjusted Recommended Shopping List Based on Account
Profile Matching

| Index | Item | Recommended Product | Origin |
|---|---|---|---|
| 1 | Eggs | {Product Description | Index Row 1 of |
| | | <Eggs><Johnson's Brand> | Table I |
| | | <Organic>} | |
| 2 | Bread | {Product | Index Row 4 of |
| | | Description<Bread><Joe's | Table 1 |
| | | Brand><Organic>} | |
| 3 | Milk | {Product Description<Milk><Bill's | Index Row 6 of |
| | | Brand><Organic>} | Table 1 |

Block 255 comprises adjusting the retrieved product lists based on other input variables. Other input variables are not particularly limited for this block. However, one concrete example can include settings within promotion manager server 128-6, whereby if certain products in the current inventory are being promoted then further changes to the recommended shopping list can change.

At this point it can be noted that block 255 can be omitted, and by the same token block 245 and bock 250 can also be omitted, to thereby provide more basic functionality within recommendation engine server 128-9.

Block 260 comprises generating a list of retrieved products for output. Block 260 generally contemplates that contents of the retrieved list are compiled into programming instructions that control the graphical interface of the relevant mobile client machine 112 in order to show the recommended list. Block 260 can comprise adding aesthetic and interactive features to the recommended list. The recommended list can appear beside a list, or the recommended list can be generated as options which can be selected on mobile client machine 112 for final inclusion or adoption into a shopping list, or even a final decision to “buy” the product(s) in the recommended list.

While method 200 can be configured to end immediately after block 260, in a present embodiment block 265 is provided. Block 265 comprises determining whether to update the list generated at block 260, or to end the method. A “no” determination leading to the end of method 200 can be based on an express termination of execution of the relevant current account holder application 113, or can be based on a transaction that ultimately effects the purchases of one or more of the various items in the recommended shopping list. Other examples leading to the end of method 200 will occur to those skilled in the art. In general, if a “no” determination is not reached at block 265, then a “yes” determination can be presumed so that the shopping list recommendations can be updated in real time. However, the means by which a “yes” determination is made at block 265, leading black to block 205 (or another relevant block in method 200, as desired) is not particularly limited, but generally emphasizes the “real time” nature of system 100. Indeed, any change in any variable considered at any block in method 200 can lead to a “yes” determination at block 265.

As a specific example, if an “in stock” variable value were to change from in any of Index Rows 1 through 6 of Table I that impacted the Recommended List in Table II or Table III, then a “yes” determination could be reached at block 265 so that the ultimate list in Table II or Table III could be updated to reflect the inventory change. Many other examples will now occur to those skilled in the art.

Having discussed how recommendation engine server 128-9 can be configured according to method 200, those skilled in the art will now appreciate from method 200, and various other teachings herein, how various other servers 128 can also be configured to operate. Some further specific discussion is as follows.

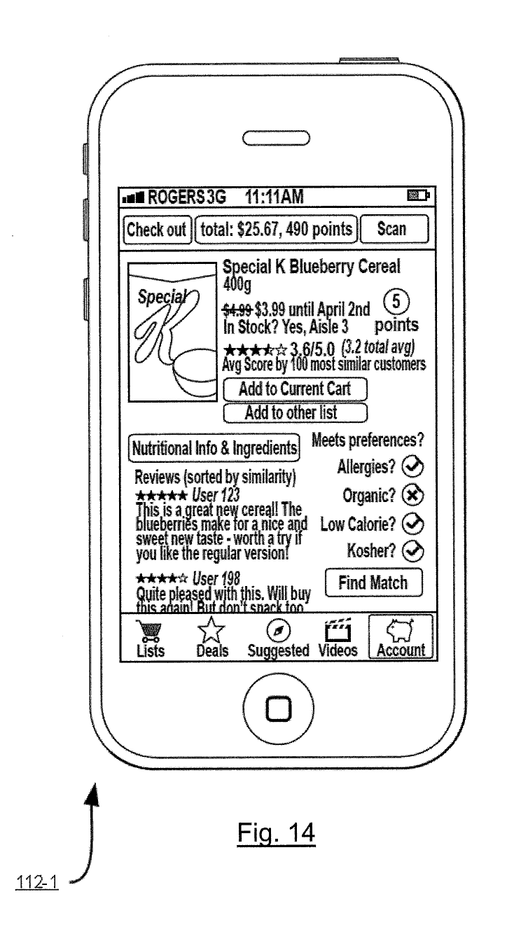

The graphical interface of each application 113 can be configured to include Product Pages that Display product information as shown in FIG. 14. Examples of information that can be shown include product Info (Description, Photo, Ingredients/materials), price, loyalty points to be earned, in-stock availability & location, current applicable promotions, intelligent reviews, and related products.

Application 113 can be configured to suggest whether a selected product meets their personal requirements according to their stored profile. If the selected product does not, a “find match” button can be generated that will allow the locating of a similar product that meets these requirements.

Application 113 can include a “Scan” button at the top right to scan a product's bar code or search by name.

Application 113 can include a “Checkout” button” at the top left to display the member's loyalty ID and perform mobile payments.

Application 113 can display the current total of items added to the basket along with points to be earned. Pushing the “add to cart” button automatically updates the total.

Application 113 can be configured so that if product is not in stock, then a “Find Location” button can be provided.

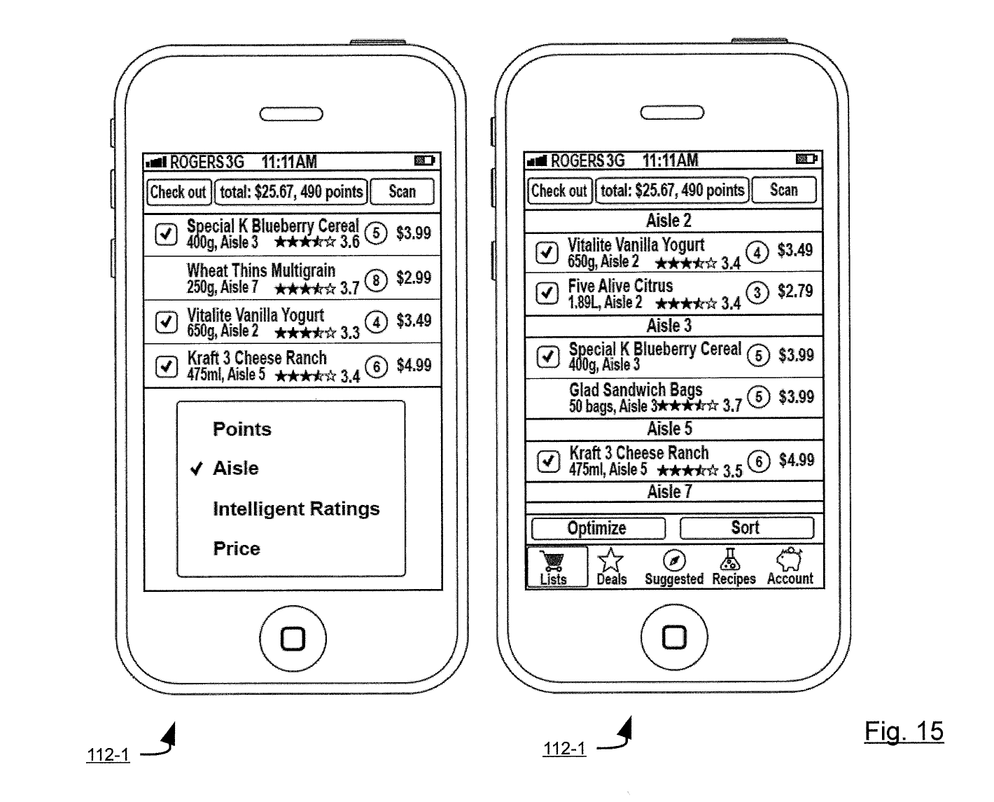

Application 113 can be configured so that, a shopping list can include a list of all items added to the list. As shown in FIG. 15, the items can be shown along with product details such as price, loyalty points to be earned, product location, and intelligent rating.

The shopping list can display total price of all items in the list, along with the amount of loyalty points to be earned.

The shopping list can be configured to allow virtual “checking off” once an item has been located in the retail store as shown in FIGS. 8, 15, and 16. Checking/un-checking an item automatically updates the total price & points.

In order to make shopping decisions more easily and locate products more quickly, the list can be sorted based on one or more of criteria price, product aisle, intelligent ratings (average rating by most similar customers), and points.

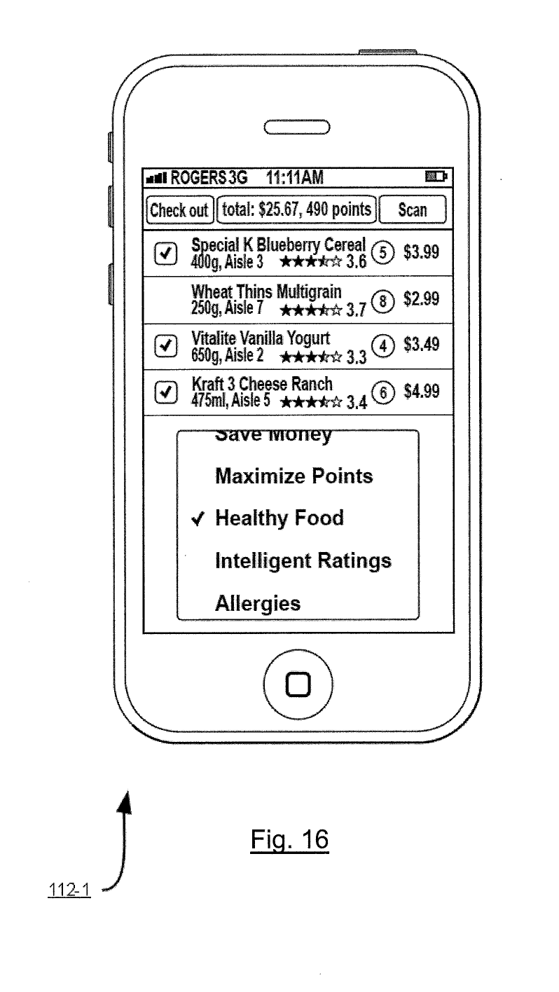

The shopping lists can have personalized optimizations such as leveraging all of the past behavior as per a stored account profile as shown in FIG. 16. Past behavior can include purchases and ratings, as well as the prior purchases and ratings of others, and the system can propose alternatives that it calculates the customer would prefer.

The interface of application 113 can be configured to permit browsing based on ratings by others, or other types of optimizations, such as switching all the products in the list to save money, maximize points, and using greener/healthier products.

Settings can be provided in application 113 so that suggested alternatives are never below a certain “intelligent rating”, to ensure that a product still has a likelihood of match. Thus, the suggested alternative will not always be the least expensive product if a matching threshold is set to a price or the product with the most points to maximize points. The recommendation can be configured to be a least expensive product or product with most points products that meet the required rating level.

Optimizations can indicate what the total additional cost & points would be. The application 113 can be configured to receive input to be able to accept all suggestions, a select few, or none.

The Promotions Engine server 128-6 can be configured to interact with the applications 113 so that, by default, the promotions section will display all current promotions, with those deemed as most relevant according to the relevant account profile first, based on the history and that of other similar account profiles. Those deemed most relevant will be at the top of the list.

The first two listings can, for example, configured to be sponsored promotions, for suppliers willing to pay a premium to be listed at the top. However, in order for the sponsored promotions to remain relevant, they can be configured to have to meet a certain level of relevance (such as had to have been in the top 100 promotions deemed most relevant). Taking a similar approach to Google's adWords platform, the price for these placements can be affected by whether or not clicks for these ads are received to take advantage of the promotion.

Application 113 can be configured to permit searching through promotions by product category, and sort the listings based on points to be earned, total savings, etc.

Should a retailer associated with retailer domain 104-2 choose that discounts or promotions need to be opt-in, application 113 can be configured to receive product bar code scans from a respective mobile client machine 112 to earn the discount, or select the discount via the application.

As noted above, application 113 can be configured for product recommendations, to identify products yet to be purchased that other customers have rated highly. Application 113 can be configured to suggest products others rated highly in the past but have not recently repurchased.

Recommendations engine server 128-9 can also be configured to leverage items listed in the shopping lists to identify highly correlated products. For example, if an account profiles indicates a previous purchase of pasta and pasta sauce, then recommendation engine server 128-9 can be configured to recommend a parmesan cheese. The parmesan cheese recommendation can also be chosen according to a parmesan cheese that is purchased and enjoyed by others with similar account profiles. As another example, a big-screen TV shopping list selection might result in recommendation for a compatible wall mount and cables.

For retailers associated with the retailer domain 104-2, this can create automated cross-sell opportunities that can be incorporated directly into, for example, ad campaign manager server 132-3 in conjunction with recommendation engine server 129-9 with suggestions are that are subjectively personalized.

Application 113 can also be configured to also allow removal of recommendations and add items to a list, and then utilize such removals to further inform an account profile and various matching thresholds, such as those contemplated at block 235, in order to improve future recommendations.

Within the retailer domain 104-2 and in conjunction with retailer specific server 128-5, certain retailer-specific features can be included to reflect the expertise of the retailer in the set of products they sell, including the opportunity to deliver features specific to their business via the application.

For a grocer, for example, this can include an ability to configure retailer specific server 128-5 to work in conjunction with other components of system 100 so that application 113 can generate recipes, including generating instructions as to how to cook those recipes, and be able to translate these recipes into shopping lists, which can then be optimized based on account profiles.

Much like a product listing, these recipes can be displayed along with an intelligent rating.

Application 113 can also be configured to save the recipe for retrieval for a later cooking time. Application 113 can also comprise as a kitchen timer, listing each step one at a time, and alerting when a next step should be commenced.

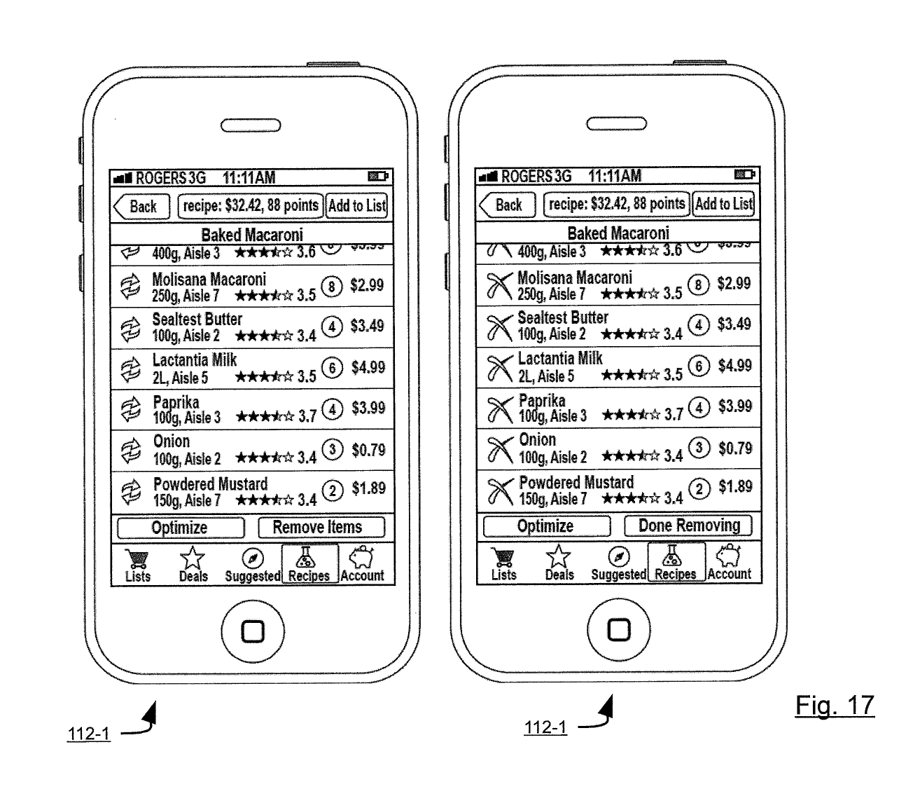

Application 113 can be configured to include a “see cost of ingredients” button and “add a recommended item to shopping list” button, resulting in the display on client machine 112 a list of all necessary ingredients, along with each product's price, aisle location, points to be earned. Application 113 can also be configured to display a total cost of the recipe (and loyalty points to be earned) as shown in FIG. 17.

Application 113 can be configured to permit editing of shopping lists in various ways, such as:

A) remove items from a recipe list that have been previously acquired, by provision of a the “Remove Item” button, with a resulting change the icons next to each product to indicate such removal, thereby removing the product from the list and adjusting the overall total accordingly; and

B) rotate individual items to competing alternatives (ie switch the coke to Pepsi). By pushing a button next to each product, a list of alternatives can be automatically provided, including both competing products, and the same product in different quantities. When an alternative is selected, the total updated.

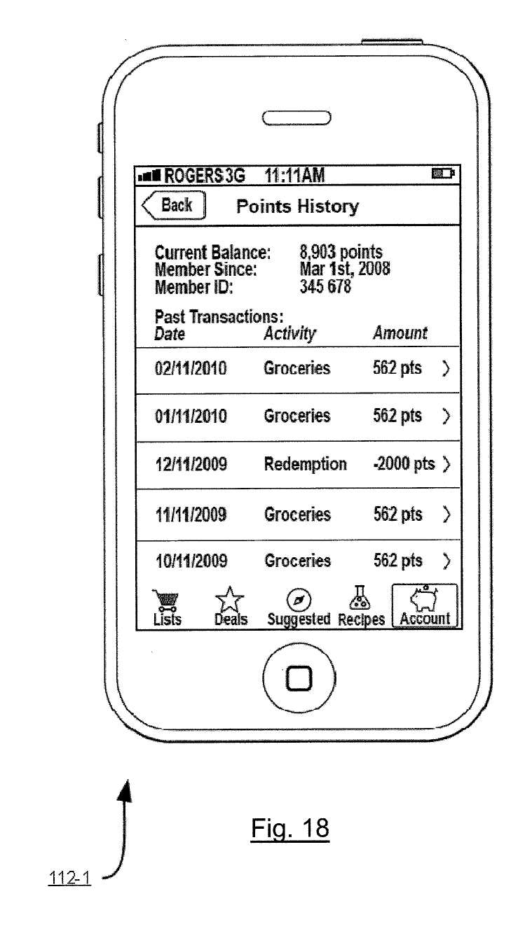

The graphical interface of application 113 can be configured to view their profiles and to records of past transactions and points earning history as shown in FIG. 18. For both the points history page and the list of financial transactions, a summary page will present them a list of all prior records. Clicking on one of them will allow access to the detailed receipt so that they can see all the products that they had previously purchased.

Thus application 113 can be configured to keep track of previous purchases, quickly access loyalty points balance, and easily find and review past purchases.

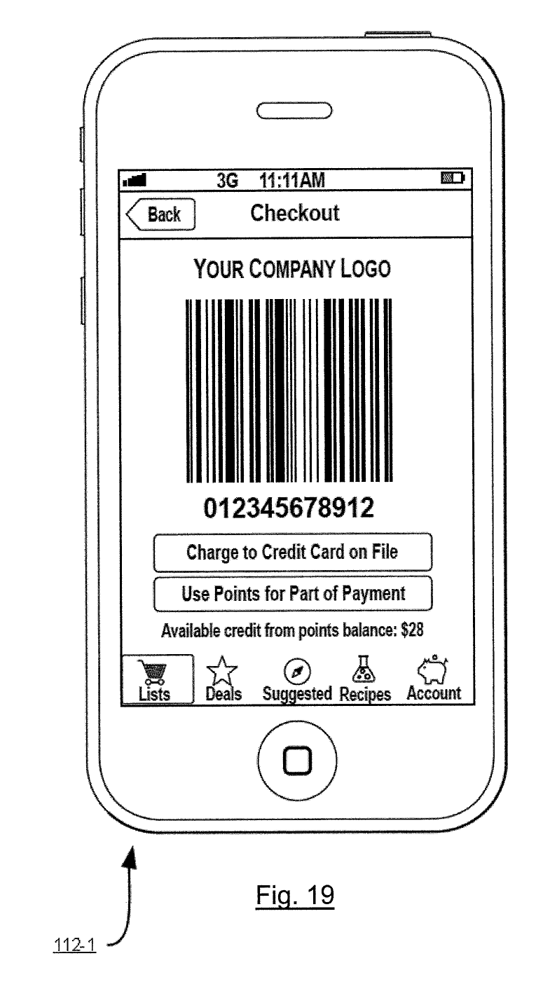

Application 113 can be configured to include a digital loyalty card, which can be presented via an output device (e.g. the display) of client machine 112 at a point of sale checkout. For example, FIG. 19 is an example showing an embodiment which presents the card in the form of a barcode.

Application 113 can be configured to store a credit card number or other financial account number so that, via application 113, at the point of sale application 113 can be used to effect the financial transaction to complete purchase.

Application 113 can be configured to effect payment with points, or a combination of cash & points.

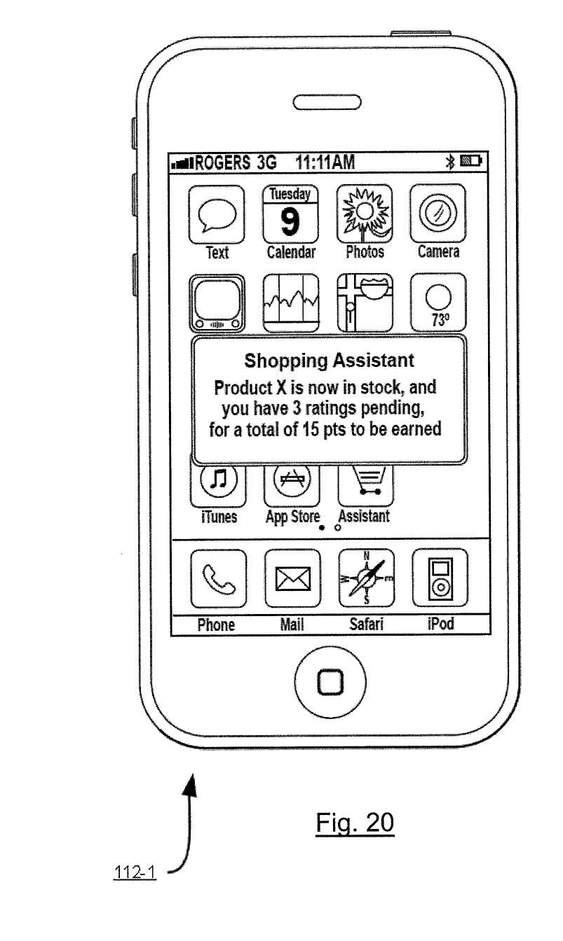

Application 113 can be configured with an account page, permitting selections of criteria in which an alert would be generated such as the one shown in FIG. 20. Such alerts can provide a pop-up message on the display of client machine 112, even if application 113 is not currently executing. Examples of situations in which an alert can be used for include: different types of special offers & discounts; a product being in-stock; and loyalty points to be earned, pending a reviews/ratings.

System 100 can be configured to provide of a web-based experience that offers the majority of the same features as those in the mobile phone application. All account details, settings, history, etc. will be stored in an online account, also known as a “cloud”, as opposed to directly on the client machine 112-1. As a result, different client machine platforms can be chosen.

System 100 can be configured so that a shopping list made through an account initially access via a desktop client machine 112 will be retrievable using the same account credentials on a smart phone client machine 112, and vice versa. Any and all information is saved to the online account and is retrievable whenever credentials are provided, regardless of the client machine 112 selected.

System 100 is generally configured to permit recording of preferences and behavior associated with different accounts and the updating of account profiles accordingly. Analytics engine server 132-1 can for example, be used to identify purchasing and shopping patterns, preferences, and automatically adapt the experience via application 113 accordingly, and to leverages the collective behaviors recorded in all account profiles, to find the most similar account profiles.

System 100 can also allow retailers to sell account profile data to suppliers, and allow the retailer and supplier to provide minable data that can be used to analyze product interactions across the entire purchase cycle for in-store purchases. Furthermore, the smart phone application 113 can also serve as a real-time marketing channel. Therefore, retailers and suppliers can have the opportunity to instantly leverage their information and insights to create any number of offers to as select a group as they choose.

Various components and features are thus provided in system 100. It will be appreciated by a person skilled in the art that not all features and components described are necessary and that some are optional. Examples of certain system potential components relating to the customer experience include product pages for each inventory item, intelligent reviews/ratings platform, bar code scanning, inventory synchronization to show product availability and location (eg. aisle in store), shopping list management, shopping list optimization based on price, points, reviews, or other (ex: only diabetic-friendly, green products, etc), totals displayed for running balance, points to be earned, amount saved, recommendations platform, section for special offers/discounts, retailer-specific applications, such as linking recipes to shopping lists, video FAQs, user account creation & management (such as loyalty points management, shopping preferences, communication preferences, alerts, and preferred optimization method), digital loyalty card, mobile payment processing (such as credit card storage on profile, for instant payment via phone and full or partial payment via loyalty points), and website integration, for consistent and connected experience via computer.

Examples of certain system potential components relating to Retailer & Suppliers Tools include loyalty currency support for existing currency, third party currency, or currency creation, real-time web-based dashboard analytics for all tracked data, real-time web-based portal for marketing campaign management, offer creation, and third-party access management (supplier's access to data & marketing channel).

Application 113 can be configured so that an average rating score of a product on a product page can be based on, for example, an average score from the most similar account profiles. Recommendation engine server 128-9 can identify similar account profiles based on information such as purchase habits, prior ratings, preferences, etc. Additionally, reviews are can be by listing those of the most similar account profiles first; thus, the top review would be by the most similar account profile, and the last would be by the least similar customer. The recommendations engine server 128-9 can also leverage purchase and rating info from similar account profiles to provide the best possible suggestions. Shopping lists can also be optimized based on what alternative is most likely based on ratings stored in similar account profiles.

System 100 provides a combination of reviews, product information, personalization, recommendations, a digital loyalty card, and the ability to incent ratings and reviews with loyalty points.

System 100 can be configured to transfer of promotions generated on client machine 112 to point of sale register at the time of checkout. This can be effected by generating a bar code on the display of the relevant client machine 112, which in turn points to the client account. The point of sale system can then access promotional prices for which the account is eligible from, for example promotion engine 128-6. Additionally, the software that will enable this exchange of information will function on any point of sale system.

System 100 can be configured to integrate with multiple retailer platforms. The software will be built to easily integrate with the multitude of different retailer technology platforms for their product inventory, POS systems, web store, etc.

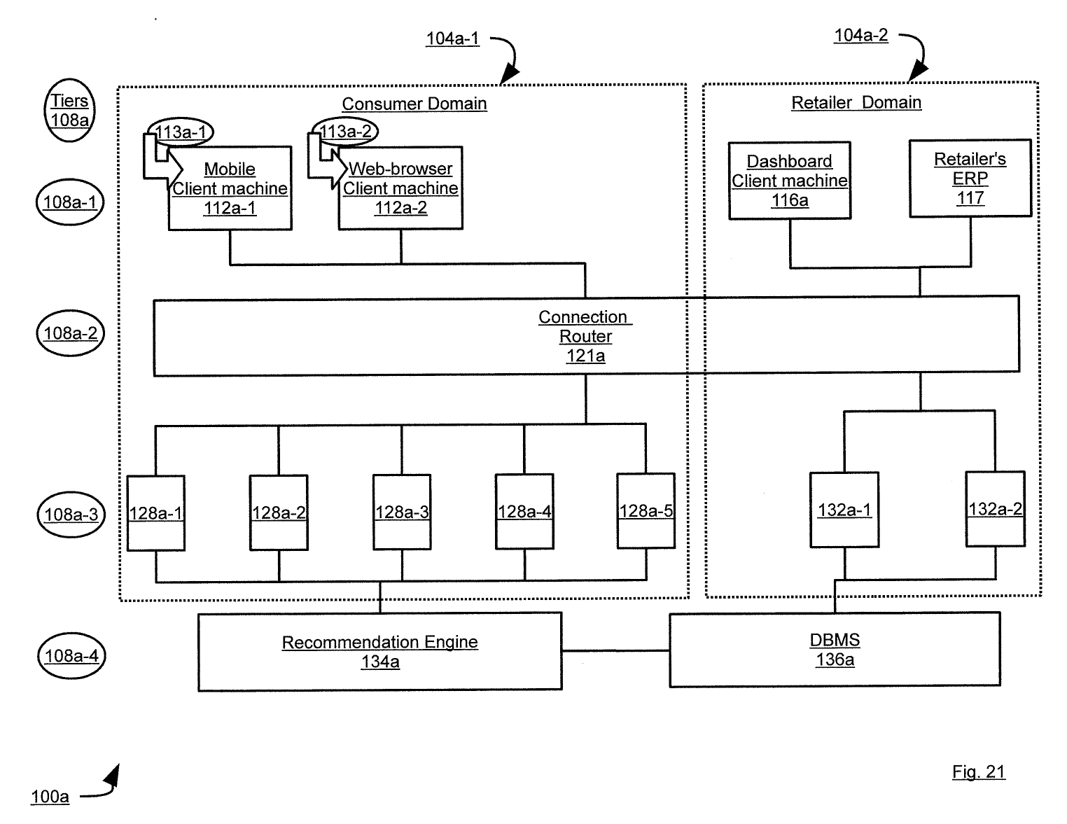

Referring now to FIG. 21, an integrated consumer, retailer and supplier computing system in accordance with another embodiment is indicated generally 100a. System 100a is a variation on system 100, and therefore elements in system 100a bear like references to their counterpart in system 100, except followed by the suffix “a”. Of note however, is system 100a, servers 128-6, 128-7, and 128-8 are omitted, illustrating that the present specification contemplates usages of different combinations of servers 128 in different embodiments. Furthermore, it will be appreciated that different number of servers 128a may be used in different embodiments as exemplified in the difference between system 100 and system 100a. In addition, it should also be noted that the absence servers 128-6, 128-7, and 128-8 does not mean that only the promotion manager server, product manager server and store manager servers may be omitted. The exclusion of these three servers exemplifies that not all servers in system 100 are essential, and that different combinations of servers are contemplated.

Also of note is that only a single connection router 121a is used across both domains, in place of router 120 and router 124. In this embodiment, the connection router 121a is for the purpose of directing requests and responses from the consumer domain servers 128a and the retailer domain servers 132a. Therefore, it is possible to use a highly available and scalable router in order to reduce maintenance efforts and related costs relative to implementing separate consumer connection router 120 and retailer connection router 124 as described in a previous embodiment. It will now be appreciated by those skilled in the art that in further embodiments, several routers may be used instead of a single connection router. However, unlike the previous embodiment, the routers used would be functionally identical in that each router is configured to direct requests and responses from servers in both the consumer domain and the retailer domain.

In addition, within retailer domain 104a-2, tier 108a-1 also includes a retailer's enterprise resource planning (ERP) machine 117. The ERP machine 117 hosts one or more integrated software programs that manage operational data for the retailer's organization. The data may include financing & accounting data, merchandise planning & assortments data, pricing data, sales and distribution data and customer relationship management data. It would be appreciated by one skilled in the art that the ERP machine 117 is the primary data provider for product and customer data.

Tier 108a-4 comprises a recommendation engine server 134a and a DBMS 136a. All servers 128a are ultimately connected to the recommendation engine servicer 134a. Working in conjunction with other servers 128a and the DBMS 136a, the recommendation engine server 134a is generally configured to automatically provide a prioritization of products for a given account and, based on that prioritization, generate information about those products on a graphical interface of a given client machine 112a associated with that given account. In contrast to the system 100 where a recommendation engine server 128-9 was in Tier 108-3, the recommendation engine server 134a is logically moved to Tier 108a-4. This is advantageous because the purpose of recommendation engine server 134a is to perform complex calculations based on data provided by servers 128a, and storing the results in DBMS 136a. Therefore, creating a new tier for recommendation engine server 134a is optimal based on the data flow within the solution.

The database management system (DBMS) 136a that manages all aspects of data of interest to in the system. In contrast to system 100 where a separate consumer DBMS 136 and Retailer DBMS 140 were used, system 100a combines the functionality of both into a single DBMS 136a. The combined data from the retailer domain 104a-1 and the consumer domain 104a-2 creates internal tables within DBMS 136a. Therefore, using a single DBMS 136a reduces the computation time required to read and write data from the retailer domain 104a-1 and the consumer domain 104a-2 relative to implementing a separate consumer DBMS 136 and retailer DBMS 1340 as described in a previous embodiment.

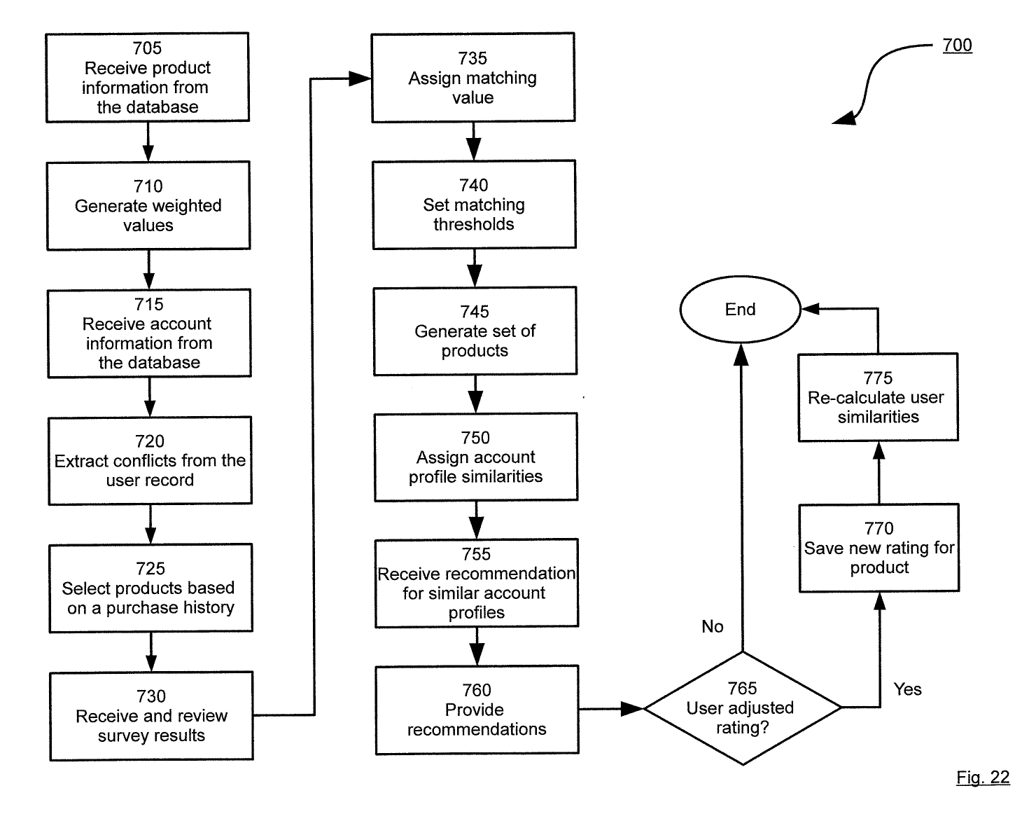

Various processes and methods can be effected using to system 100a, and its variants, according to the teachings of the entirety of this specification. One non-limiting specific example of a method that can be effected using system 100a is shown in the form of a flowchart in FIG. 22 and indicated generally as 700. Method 700 is a computer-based method for generating product recommendations. As noted above, method 700 can be implemented using system 100a or variants thereon. However, for purposes of explanation, method 700 will be described in relation to system 100a. Note that while method 700 is shown as a sequence of blocks, those blocks need not necessarily be performed in the order shown, and indeed certain blocks may be performed in parallel with other blocks.

Block 705 comprises reading product information from the database. In particular, product information associated with a plurality of products in a product inventory database is received. The products are stored in the DBMS 136a, and are populated via connection router 121a using a server 132a. Once connection router 121a selects a random server from the group of servers 132a, it will continue to use that server for subsequent requests. The recommendation engine server 134a reads the data from DBMS 136a directly. The engine reads the products' key features, such as price, ingredients and nutritional info for grocery products. The features data is then stored in temporary structures in-memory for further processing.

Block 710 comprises of an algorithmic calculation of a products' features and storing the results in a collection contained in DBMS 136a. A plurality of weighted values for each product based on the product information is generated. The weighted values may be based on a subjective metric (eg. user ratings) and/or an objective metric (eg. the amount of an ingredient in a product). The calculations are performed by recommendation engine 134a, and are based on the value of the key features of the products read during Block 705. The values for the features are normalized: each element is scaled by the total number of elements. The goal is to achieve scale invariance in order to comparatively analyze features with different units of measures. The results of the normalized calculations for all features for a product are stored in a new collection in DBMS 136a. These results are used further on in method 700 to match the top products based its features with consumers' personal preferences.

Block 715 comprises the receiving account information from account profiles in the database. The account profiles are stored in the DBMS 136a, and were populated via connection router 121a using a server from group of servers 132a. The recommendation engine 134a reads the data from DBMS 136a directly. The account profiles are read and stored in temporary in-memory structures for further processing.

Block 720 comprises of the extraction of conflicts based on the account profiles read in Block 715. The conflicts stored in the database are defined in the account profile. The conflicts represent a grouping of ingredients for a product that would prevent the user from buying the product. For example, if an account profile is associated with a gluten allergy, products containing wheat would be of no interest whatsoever. The extraction of the conflicts is performed by the recommendation engine 134a. Once the conflicts have been extracted, they are compared with the ingredients of products read in Block 705 using natural language processing. If a products' ingredient belongs to the set of ingredients associated with a conflict, then the rating for the product for that account profile is defined to be ‘−1’ and stored in a new table in DBMS 136a. The value of ‘−1’ ensures that the product will always fail to meet the match threshold, and subsequently never be recommended. The matching process between conflicts and products is dependent on the descriptive nature of the products' features. For example, a product representing “chicken” must include “chicken” in its ingredients so that it is excluded from the result set for an account profile with “meat” included in the conflicts. Therefore, the possibility for errors exists for cases where the ingredient list is incomplete, uses non-standard language or if a conflict set is missing an ingredient. It will now be appreciated by one skilled in the art that extraction of conflicts may not be necessary. For example, a person without any allergies may not require a check for conflicts.

Block 725 involves selecting a set of products from the plurality of products based on the account information. For example, the selection process may involve reviewing the purchase history of an account profile, determining the most purchased products, and extracting the features of the most purchased products. The purchase history is provided by the retailer via connection router 121a, and is stored in DBMS 136a by a server 132a. Each purchase is analyzed by the recommendation engine server 134a. The products are extracted, and the features of the products are calculated as per Block 710. The ratings of the product are determined based on its frequency in the purchase history. For example, if “skim milk” appears in 85% of the purchases, the features of milk (high in calcium, low in fat/calories) will be analyzed and the existing feature preference will be adjusted to factor in the features of popular product purchases. The results of the purchase history analysis are stored in a collection in DBMS 136a.

Block 730 involves receiving at least one survey result from another client machine. The survey is sent to random client machines such as 112a-2. The client machine 112a-2 must return ratings for 50 products, with the ratings between one and five (five being a product they would very likely buy, one being a product they would not buy). The results are stored in DBMS 136a via connection router 121a and one or more servers 12a. The recommendation engine 132a reads the survey results, and the features of the products are calculated as per Block 710. The ratings for the products surveyed are extracted directly from the survey results and stored in a table in DBMS 136a. The ratings for other products are calculated based on the features extracted for the products in the survey and conflicts, and are stored in a collection in DBMS 136a. It will be appreciated by a person skilled in the art that the rating system between one and five is merely exemplary. In other embodiments, the rating system may be a binary rating (eg. “recommend” or “not recommend”) or may involve a different range that is larger or smaller. In other embodiments still, symbols or letters may be used instead of numbers.

Block 735 involves assigning a matching value to a product based on the weighted values and the at least one survey result. This involves compiling values to the matching variables contemplated at block 725 and 730, based on the specific responses received at blocks 710, 720, 725, and 730.

Block 740 involves defining a predetermined range of values which would result in a match. For example, this may involve setting matching thresholds. In general, the matching threshold defines a predetermined range in which the matching value may fall. Matching thresholds are defined as percentile scores globally or on separately for each account profile. Products belonging to a percentile above the threshold will be recommended. For example, if the threshold percentile is set to 85%, then only products with scores in the top 15% will be recommended. If however a particular account profile has a large product recommendation set in the top 15%, then the percentile can be modified to only recommend the products with scores in the top 5%.

Block 745 involves generating a set of products with matching values above the matching threshold of the account profile and saving in a table in DBMS 136a.

Block 750 comprises the calculation of similarities between two or more account profiles. Purchase histories associated with different profiles are populated by the retailer using connection router 121a, into DBMS 136a via a server 132a. The calculation is based on matching similar products in the purchase histories of other account profiles with the products analyzed in Block 725 for the present account profile. A similarity score is determined using the Jaccard similarity coefficient. Based on a threshold value, account profiles are then selected and deemed to be “similar” to the current account profile. The similar account profile list is saved in DBMS 136a.

Block 755 comprises receiving at least one recommendation associated with the second account profile if the similarity coefficient is above a similarity threshold. Block 755 thus comprises comparing the current account profile from block 715 with the other account profiles and then filtering so that only certain other account profiles that have common characteristics (i.e. that meet or exceed the matching thresholds) with the current account profile are preserved.

Block 760 providing a list of recommendations which include recommendations associated with the second account, if any, and products from Block 745. Block 760 generally contemplates that contents of the retrieved list are compiled into programming instructions that control the graphical interface of the relevant mobile client machine 112a in order to show the recommended list. Block 760 can comprise adding aesthetic and interactive features to the recommended list. The recommended list can appear beside a list, or the recommended list can be generated as options which can be selected on mobile client machine 112a for final inclusion or adoption into a shopping list, or even a final decision to “buy” the product(s) in the recommended list.

While method 700 can be configured to end immediately after block 760, in a present embodiment block 765 is provided. Block 765 comprises determining whether the rating is accepted for a recommended product. A “no” determination leading to the end of method 700 can be based on an express termination of execution of the relevant current account holder application 113a, or can be based on accepting the product recommendation. However, the means by which a “yes” determination is by a modification to the estimated rating of a product.

Block 770 is a continuation of a rating of a product. Once the rating of a product is defined, the rating is stored in DBMS 136a and subsequently returned to the client machine 112a whenever the product is viewed in the future. This represents the end of method 700.

Block 775 comprises of the scenario whereby the estimated rating of a product is rejected and a new rating for the product is specified. In this case, recommendation engine server 134a must re-calculate the user similarities using the same process/calculation method defined in Block 750.

While the foregoing discusses various specific embodiments, it is to be understood that variations, combinations and subsets of those embodiments are contemplated. For example, various blocks in method 200 or method 700 may be omitted, and likewise various blocks in method 200 may be combined with various blocks in method 700.

A general aspect of this specification provides a technology-based loyalty platform built for retailers, allowing for the delivery of an enhanced and automatically personalized in-store shopping experience via a smart phone application. Acting as a personal shopping assistant, the specification can provides individually unique and relevance-focused experience. Current mobile retail solutions provide generic content—such as product catalogues—while the present specification contemplates “intelligent” smart phone or other client machine applications.

Another aspect of this specification provides product system and method for scanning a product bar code and finding information such as price, the number of loyalty points to be earned, a description, the materials/ingredients, reviews and ratings, and related products. In certain implementations, that content will be personalized, in that the price and loyalty points offered can be uniquely created.

In other aspects, product ratings can be based on the average scores and reviews are listed from accounts having similar profiles. Furthermore, product preferences can be set and to determine if a scanned product meets their criteria, such as for allergies, green-friendly products, etc. If the scanned product does not meet the account profile preferences, the application can help to find an alternative product that does.

Shopping list tools are provided for tracking their price and points balances in substantially real time (i.e. during a shopping outing), providing the ability to sort a pre-arranged or default shopping list by price or points in case the totals do not meet a predefined budget, and offering sorted lists by aisle for shopping convenience. The present specification includes a system that can offer the ability to optimize an entire shopping list or individual products to alternative based on different input variables, such as price, loyalty points, rating by similar customers, etc. The system can provide users with product recommendations, leveraging previous purchases, ratings, and those of similar customers. The system can also contain a promotions section, where promotions will be sorted in order of relevance.

In other aspects, a graphical interface on a client machine provides new ways to earn loyalty points through exclusive promotions, points for ratings & reviews, and a digitized loyalty card. A mobile device version of a client machine can be enabled for mobile payment, so that the device can substitute for the member's wallet.

In other aspects, depending on the retailer's vertical, other features are available; for example, a grocer's application can include recipes that can instantly be turned into a shopping list. Thus, a member could walk into the grocer's store, pick a recipe most enjoyed by similar customers, convert it to a shopping list, optimize the list to the healthiest alternative products, excluding any products to which the user is allergic, sort the list by aisle, pay for it quickly with their phone at checkout, and have the application assist them in cooking the meal once at home. Finally, the application builds a rapport with the customer; the more data is collects, the more relevant the experience will become, giving the customer an added incentive to return, and rewarding them when they do.

In other aspects, the present specification provides a personal shopping assistant, helping users to find the right product given their wishes and preferences, thus accommodating all types of shoppers. The present specification also permits retailers pick whatever mix of features they desire, so that the solution fits and evolves with their customer strategy. This also allows for phased implementations of features.

With its focus on data, the present specification also provides retailers with a new source of real-time analytics and is the first analytics solution for in-store behavior that allows retailers to see who is interacting with their products across the entire purchase cycle; this includes actions preceding purchase, such as looking up a product, being exposed to a promotion or recommendation, as well as adding it to a shopping list. This data can be compared against who actually purchased the product, creating a wealth of insights never before possible for in-store behavior; marketers will be able to uncover new segments of customer prospects they never knew existed, for every one of their products.

Furthermore, a smart phone application can doubles as a real-time marketing channel, where promotions can be listed. Thus, retailers can be provided with the ability to instantly leverage their insights and create any number of offers to as select a group as they choose. Thus, it enables 1-to-1 marketing, mass marketing, and everything in between. It allows retailers to influence customer behavior at the point of purchase. For example, a retailer could target their promotion to customers who have shown interest in a product but never purchased it. Since the retailer would not be spending any promotional funds on customers who already purchase the product, the promotion can be much richer.

The present specification can also allow the retailer to sell access to the data and marketing platform to its suppliers, and empower the retailer with tools to manage supplier involvement and data visibility. Thus, a system configured according to the present specification can adjust to, and evolve with the retailer's strategy. The present specification solution can strengthen alignment between the retailer, its customers and its suppliers by getting the right product to the right customer at the right time. It can also enhance a retailer's existing customer loyalty strategy; it can also accommodate and support a retailer's analytics firm as well as embed and endorse a loyalty currency.

The present specification can also provide retailers with three core avenues to build profits. First, revenue generation is increased as a result of customer loyalty/engagement, new customer acquisition, up-selling & cross-selling, and the ability to target and re-engage old customers that adopt the application. Second, Costs are-cutting via data that yields in-store efficiencies. Third, revenue is generated from suppliers through sale of data and fees from the advertising & marketing channel.

Certain benefits are also provided this specification, namely, the ability to white-label a mobile solution, with direct integration into a retailer's systems; the ability for retailers and their suppliers to leverage real-time data for real-time data analysis & marketing; the ability to collect information on participating customers across the entire customer purchase cycle; a personalized consumer shopping experience, unique for every customer, via the mobile phone; automated personalization adjusting in real-time vs. a segmentation approach devised by a marketing team; and the delivery all of these benefits for customer interactions within a bricks and mortar environment.

The present specification contemplates the usage of smart phones as platforms to deliver the novel technology contemplated in this specification, due to exponentially rising adoption of these devices, the profile of smart phone users, and the cost benefits for deploying the necessary infrastructure given that consumers have already paid for the device.

The present specification also provides loyalty solutions provider that delivers “intelligent” smart phone-based systems to large chain retailers. This platform allows retailers to create loyalty by delivering their customers an enhanced in-store buying experience via a smart phone application, which includes user-specific, user-relevant content, as well as all the benefits of a traditional loyalty program. Loyalty is created through points as well as by enhancing the entire customer experience. Through this platform, all customer behavior and preferences are recorded and calculated. In observing behavior, this system is able to learn exactly who the customer is, what they like, and automatically adapt the experience accordingly. The end result is a platform that delivers unparalleled relevant content to the customer. Furthermore, this constant tracking allows the system to continuously improve itself and provide more relevant recommendations to the end user.

This platform will also allow retailers to sell customer data to suppliers, and will allow the retailer and supplier to understand who is interacting with their products across the entire purchase cycle, including actions preceding purchase. Furthermore, the customer's smart phone application doubles as a real-time marketing channel. Therefore, retailers and suppliers will have the opportunity to instantly leverage their information and insights to create any number of offers to as select a group as they choose.

This system, which connects all three parties—the consumer, the retailer and the supplier—enables an optimized experience for each group. It allows for completely optimized marketing campaigns and allows the right product to reach the right customer at the right time.

This system brings the tools and analytics that have for year benefitted online shopping portals—into the physical retail world. Customers can enjoy the benefits of an intelligent online shopping experience within a bricks and mortar environment while retailers and suppliers will have access to real-time data never before recorded; for the first time, it will allow for the monitoring all customer behavior within the physical environment, including all actions preceding and following purchase, for every item with which they interact.

The present specification thus provides retailers with at least core avenues to build profits:

1. Revenue generation via increased customer loyalty/engagement, new customer acquisition, up-selling, and the ability to target and re-engage disengaged customers

2. Greater efficiencies from in-store operations

3. Revenue generation from suppliers through (1) sale of data & (2) fees from the advertising & marketing channel

The present specification contemplates the following customer experience components & features:
Product pages for each inventory item
Intelligent reviews/ratings platform
Bar code scanning
Inventory synchronization, to show:
   a. product availability
   b. product location/aisle in store
Shopping list management
Shopping list optimization based on price, points, reviews, or other (ex: only diabetic-friendly, green products, etc)
Totals displayed for running balance, points to be earned, amount saved
Recommendations platform
Section for special offers/discounts—Retailer-specific applications, such as linking recipes to shopping lists, video FAQs
User account creation & management, including:
   a. General user information
   b. Loyalty points management
   c. Shopping preferences, communication preferences (including alerts), preferred optimization method
Mobile payment processing, including:
   d. Credit card storage on profile, for instant payment via phone
   e. Full or partial payment via loyalty points
Website integration, for consistent and connected experience via computer

The present specification contemplates the following Retailer & Suppliers Tools:
Loyalty currency support for existing currency, third party currency, or currency creation
Real-time web-based dashboard analytics for all tracked data
Real-time web-based portal for marketing campaign management, offer creation
Third-party access management (supplier's access to data & marketing channel)
Tools for store layout & management optimization

The present specification contemplates a smart phone application comprising a personal shopping assistant that supports all of the following features, effectively positioning the retailer as the true “expert”, or best resource for all things related to its product category.

1. Individual Product Pages for All Inventory Items with Integrated Personalization

Similar to an online store, customers will have the ability to look up individual product to retrieve standard information such as product description, a photo and the ingredients/materials. However, it will also display all the following information in a fashion that's tailored to the user:

a. Price & Loyalty points to be earned: due to the system's ability to enable targeted pricing and promotions for retailers and suppliers, some customers might be eligible for special offers & prices

b. Reviews & Ratings: reviews and ratings will be those of similar customers. see below for more info

c. Related products: Will display highly correlated products enjoyed by similar customers

d. Whether or not the product meets the user's preferences: Users will be able to set requirements for a product, such as not containing an ingredient to which they are allergic, being kosher, or green-friendly, etc. If the product does not meet the user's requirements it will allow them to find an alternative that does, and will suggest the product highest rated by similar customers. The requirements that users will be able to set will vary from one retailer to the next, and will be at their discretion of the retailer to decide how they would like to allow their products to be filtered.

2. Intelligent Reviews & Ratings for Offline Sales

The present specification contemplates a reviews and ratings platform that will not only display the item's total average rating, but also the “intelligent rating”: the average score by the 100 customers most similar to the user based on prior purchases and ratings. In accordance, reviews will be listed in order of the commentator's similarity to the current user. Thus, every user's experience is unique.

Capitalizing on the Twinsumer effect, which is the effect of a group of consumers buying products based on the review of others. This provides the most relevant rating & review experience possible, and will have a strong impact in building higher consumer confidence, and subsequently, diversifying/growing sales, as users will expand the products they consider as a result of the added information.

Since the system will keep track of what items the consumer has purchased, it is the first system that will be able to prompt reviews for all offline sales. By prompting all sales for reviews, this will help to build the credibility of the reviews & ratings across the system.

Ratings & reviews can be incented via loyalty points. This can be set up on a permanent basis, or temporarily, for purposes such as building an initial review database; all can be controlled and changed by the retailer. This can also be done for all products or individual ones. This is especially useful for new products launched with no reviews.

The application can also prompt users to review items a certain amount of time after sale, depending on the user's preference settings and the item in question.

3. Bar Code Scanning

Within the application, is the ability to scan an item's bar code, using their phone's camera. Once identified, the application will automatically pull up the scanned product's page, containing item information, reviews & ratings, as listed above.

Consumers will also be able to find a product's page by typing in the first few letters of the Product Description, and then selecting the correct one from a list of corresponding products.

4. Inventory Synchronization, Aisle Listings

On each product page, the product's stock level will be shown, as the application is configured to determine the store in which the user is shopping via GPS. If the selected item is out of stock, the application will inform the user of the closest location is where it is in stock and provide directions via integration with Google Maps or other mapping services.

For items in-stock, the system advises the aisle where the product is located. The product's aisle will be listed on its product pages, but this feature can be applied to a user's entire shopping list; sorted by aisle, it would allow customers to navigate the store as quickly as possible and find items easily (i.e. pick up the following items on aisle 1, the following on aisle 2, etc).

5. Interactive Shopping Lists, Running Totals, and Automated Lists

The smart phone application will allow:
Creation of digital shopping lists by accessing product pages through search/bar code scanning and pressing “add to cart”.
Adding products to lists by scanning items at home that they'd like to replenish, items at a friend's house, or at another store, avoiding having to write it down.
Checking off items from their shopping list as they are picked up in store.
Viewing of a running price & loyalty points totals as items are checked off, as well as the amount “saved” via discounts
Creating a “default” shopping list, based on items that are frequently purchased/highly rated by the customer. Default lists can also leverage timing of previous purchases, so that if the user bought milk the day before, it will be included in the default list, but if it has been 2 weeks since the last purchase, it would
Saving and retrieval of multiple shopping lists

6. Shopping List Optimization/Smart Shopping Lists

The application will provide the customer with a tool to take their current shopping list and have the product selection optimized based on any one of the following parameters, while ensuring that the suggestions will still be enjoyed by the customer: (many of following examples relate to grocery retailers but could be applied to other kinds of retailers)
Save money: The optimization will switch products in the list to competing brands at a lower price that are still purchased and enjoyed by customers who have similar tastes, based on past purchase and rating history. Additionally, the difference between the two lists will be displayed to show total potential savings.
Healthy food/Green-friendly: Optimization would switch items in basket to healthier/greener alternatives purchased and enjoyed by customers with similar tastes, and display the incremental cost
Maximize loyalty points: Optimization would switch items in basket to any competing product with more loyalty points and show total potential incremental loyalty points, along with incremental cost
Review Scores: Optimization would switch items in basket to competing products with the highest rating score from the 100 most similar customers, and display the incremental cost
Other: Diabetic-friendly, low calorie, kosher, etc—Other types of optimizations could be created depending on the retailer and different customer segments they may have

All optimizations will provide the option to accept/not accept the suggested changes, or accept only certain changes.

7. Product Recommendations

The application can contain a section dedicated to product recommendations, leveraging a customer's previous purchases & ratings as well as those of all other customers. The system can be configured to identify customers with similar tastes and identify products that they rated highly that have yet to be purchased by the user. The application can be configured to receive “votes” on recommendations, either adding them to their list or removing the recommendation, allowing future recommendations to be improved.

Recommendations will also leverage items listed in the user's shopping list to identify highly correlated products. For example, if the user has added pasta and pasta sauce to their cart, it might recommend parmesan cheese enjoyed by similar customers. Alternatively, a user purchasing a big-screen TV might get a recommendation for a compatible wall mount and cables.

8. Section for Special Offers/Discounts

The application can be configured to contain a section dedicated to all current promotions or discounts. By default, promotions will be listed in order of what is deemed to be most relevant to the user, leveraging the same process as the recommendations engine. Users will be able to sort through these by product category, or search for a product. Promotions and discounts will also be listed on individual product pages.

Should a retailer choose that discounts or promotions need to be opt-in, the application can be tailored so that users must scan a product to earn the discount, or select the discount through the application.

Retailers may choose to have offers available exclusively through the application, which would thus not be reflected on the printed aisle price. BUT, since users would not be expected to scan all individual products to find specials, the system will allow retailers to create a unique bar code for a product category. These bar codes can be printed and displayed in the aisle next to the products to which it is associated; when users scan the category bar code, the application will pull up a list of all those products along with any current promotions. These category bar codes, which might say “Scan Here to See all Category X Promotions”, will produce digital signage for these specials and encourage users to engage with the application. If they choose, users will then be able to sort this list based on price, loyalty points, or ratings score by similar users.

9. Retailer Vertical-Specific Features

This platform can be configured to incorporate retailer-specific features that will further establish the retailer as an expert on the products they sell. Ironically, customers do not view their grocery store as a source for advice on food, or as a food expert. The same occurs with other large retailers in other industries; even in electronics stores, the customer experience can be vastly different from one salesperson to the next given the vast amount of knowledge that needs to be acquired by the employee, thereby diminishing the value that customer's place on their assistance. This inconsistent experience is a missed customer opportunity that can easily be addressed by providing this information in an easily digestible format. Addressing these issues will build customer confidence, produce a more informed and confident customer, leading to increased engagement and customer retention.

For a grocery retailer, such a feature can include the ability access recipes that can instantly be translated into a shopping list, addressing the customer's end goal. Unata's platform will enable a grocer to provide a library of recipes that users can access via the application. This also presents the opportunity to partner with a well-known chef (or chefs) to source their recipes and further draw the attention to the application and encourage adoption. Also, a retailer could opt to have the recipe tied to specific default ingredients, in order to promote certain products more heavily or sell exposure/placements to suppliers.

To demonstrate that the application can be configured to be personal shopping assistant, consider the following example; a customer in a grocery store might say to themselves, “I would like to cook seafood paella for 5 people; what should I buy?” The application would allow them to select a recipe voted highest by similar customers for that meal, and allow them to automatically create a shopping list with the necessary ingredients at the appropriate quantity. If the customer already owns one of the ingredients, they will be able to simply delete that ingredient from the list.

The customer would then have the ability to use the same optimization and sorting tools listed before. Thus, they could optimize their list (or parts of their list) to the ingredients that will earn them the most loyalty points, and then sort their list by aisle to pick up all the items in the fastest possible way.

And when the customer arrives as home, they will be able to access the same recipe and be given the step by step directions for cooking the chosen meal. And for any step that needs to be timed, the application will alert the user when a step is complete and when the next should begin. As such, the application will have users engaging with the grocer's brand even when they are outside the store, thereby increasing their loyalty to the brand.

For a big-box electronics retailer and other retailers that sell high-ticket items, the platform will allow these retailers to provide important information to their customers by means of mobile video. Effectively digitizing the salesperson, retailers will be able to produce, for example, a set of short one minute videos that address top customer Frequently Asked Questions (FAQs).

Furthermore, these video-based FAQs can be linked via any product page to which the video would apply, thereby contextually placing this information. For example, for a customer trying to figure out if they'd like to buy a Plasma or LCD TV, not only could the retailer have a one minute video to explain the differences, but this video would be accessible through any Plasma or LCD product page.

This added information will assist customers in making the right decision, and will increase trust in the retailer's brand, fostering increased loyalty. These videos can also be a great tool to insert up sell or cross sell messages, or reference another video that does so, such as “How to choose the right cables for your Flat screen TV”.

These are only two examples that demonstrate how each retailer could provide add-on features to further augment the customer experience, get users to use the application outside of the store, and ultimately engage more with the brand. For a hardware retailer, this might include tools to assist in a building project or even in paint selection. For a Golf retailer, this might entail a feature to keep track of your golf scores. Other possibilities are within the scope of this specification.

Every one of the previously listed features can help to build customer loyalty and drive additional purchases by providing missing information to the consumer that keeps them from completing a sale.

10. User Account Creation & Management

The present specification contemplates prompting for the creation of an account with the retailer's application. The customer will be asked to enter a few details, such as:
Birth Date
ZIP/Postal Code
Sex
Email address (optional)
Loyalty Account # (if they already have one)

After signup, every time the application is opened, an automatic sign-in occurs. This information will assist allow the data being tracked to be tied to the user so that the experience can be personalized.

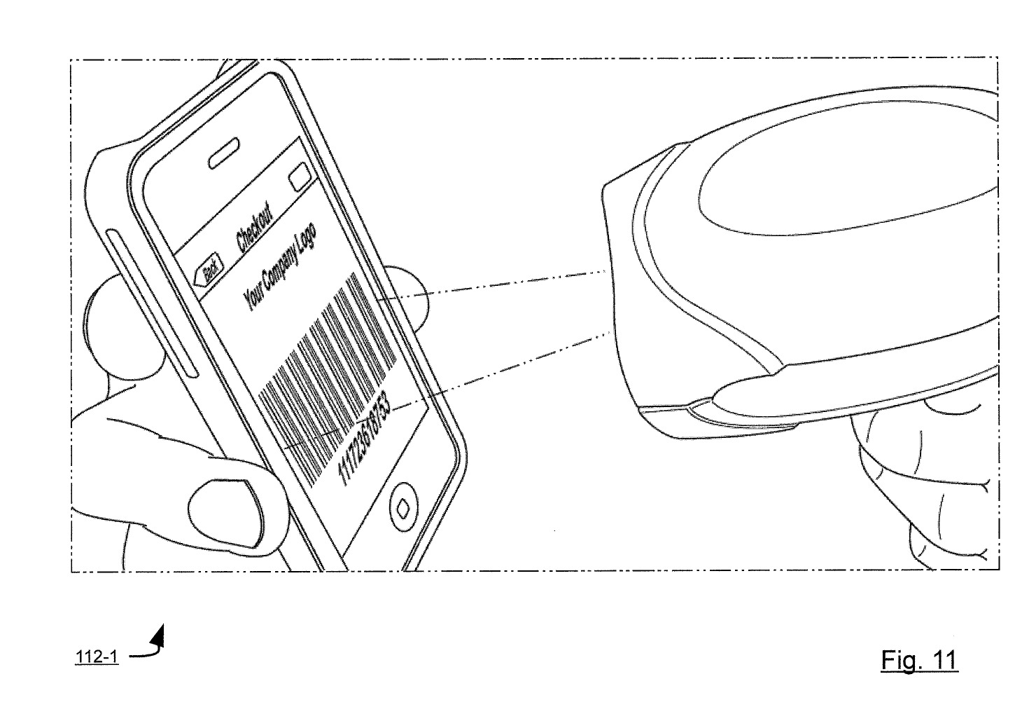

Additionally, the application 113 will allow the user to have a “digital” loyalty card. Each user's account will have a unique bar code produced for it that can be displayed on the smart phone's screen and scanned at checkout, for example as shown in FIG. 19. The barcode can act just as a regular loyalty card and would be swiped or scanned, for example as shown in FIG. 11. Once scanned, the point of sale register will update the prices and points with any specials which are available based on information associated with the barcode.

Scanning the member's bar code also allows transactions to be tied to the user's account. This is a key step as there is no other way to know what the customer finally purchased, despite what may have been on their shopping list. Furthermore, if the customer chooses not to self-identify, there is no way to prompt them for reviews of the items they purchased, as the system will not know the items in question. This in turn will also reduce the effectiveness and accuracy of the recommendations. However, this financial and points incentives address this issue, providing a compelling reason for customers to open the application and display their bar code ID.

Account Management—Preference Settings

Customers will also have the ability in the application to set multiple preferences, including:
Product requirements (must not include the following ingredients, must be kosher, must be green-friendly, etc)—these requirement settings will vary by retailer and will be at their discretion of the retailer to decide how they would like to allow their products to be filtered.
Preferred shopping list optimization scheme (price, high ratings, loyalty points, green-friendly, etc)
Amount of time post-purchase to be prompted for reviews, including “only when points offered” and “never” (although the system will encourage users to do so in order to provide more relevant recommendations)
“Alerts” settings; since marketers will be able to push targeted offers to consumers, users can choose under what conditions they would like to be alerted via their phone when they are not using the application. This would be especially relevant to “bargain-hunters”.
Users will also be able to change account details whenever they choose, including their listed home address

Account Management—Customer History

Customers will be able to monitor their loyalty points balance and observe their earnings history. Customers will also be able to retrieve lists of their prior purchases, see (or add) product ratings they provided, as well as see the total price they paid. Through the history, they will also be able to add these items to current shopping carts, making it easy to add previously purchased products that customers might otherwise have forgotten about.

The application will also save any previously compiled shopping carts that the user has created.

11. Mobile Payments, Cash+Points

Through the account page on the smart phone, customers will be able to securely store a credit card number. At checkout, once the user has had their bar code scanned, they will have the option on their smart phone to have the payment processed to the credit card saved on their account.

Additionally, for retailers willing to let their loyalty currency have a cash equivalency, users will also be able to pay in part, or in full, with loyalty points. If there is a remaining balance, this can be paid with the credit card stored on the account, or with any traditional method.

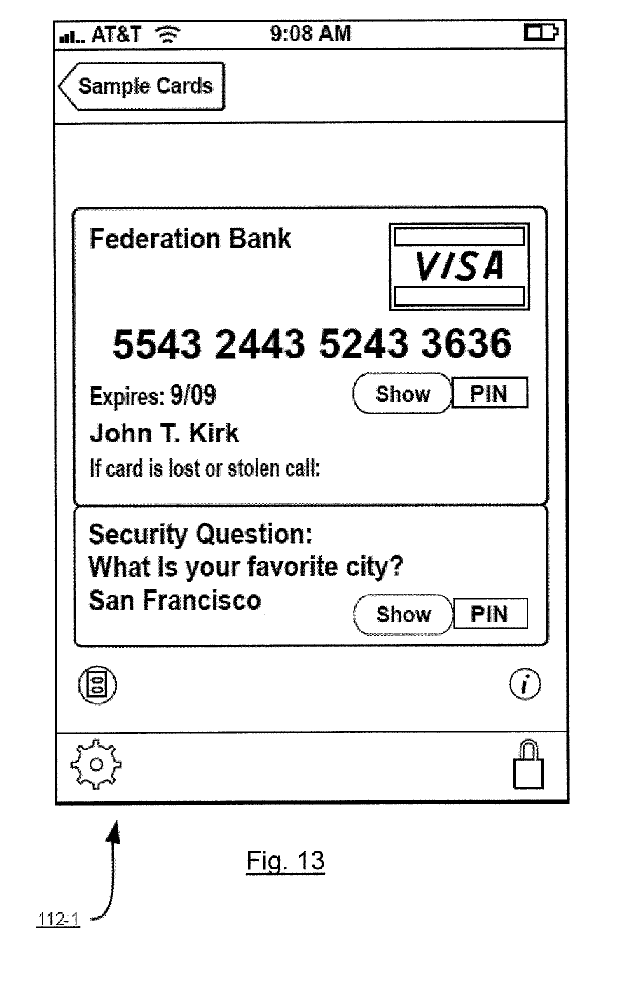

In another embodiment, the application 113 may store more than one credit card number. A credit card may be displayed on a graphical interface as shown in FIG. 13 once a credit card number associated with a specific credit card has been selected.

12. Cross-Platform Experience

The present specification contemplates the delivery of a web-based experience that offers the majority of the same features as those found in the mobile phone application. More importantly, all account details, settings, history, etc. can be stored in an online account, also known as a “cloud”, as opposed to directly on the phone. As a result, users can be able to use whatever platform they choose to do their shopping.

A shopping list made through the online store on a home desktop can be be retrievable on the smart phone app and vice versa. Any and all information is saved to the user's online account and is retrieved whenever they log in, regardless of the channel they choose to use. Furthermore, if a smart phone is lost, then the app can be re-downloaded on a new smart phone without losing any data. This approach will allow consumers to shop however they want—at home, in-store, or both—and allow these experiences to be connected.

Summary of Certain Benefits of the Customer Application:
Access to incremental product information
Quick access to information via scanning
Access to intelligent reviews (by similar users)
Personalized experience—instant and relevant offers & product recommendations
Tools to create and save shopping carts, see running total, see previous purchases
Retailer-specific applications, such as recipe-to-shopping list, of video-based FAQs
Ability to see if product is in-stock, where it's located
Tools to save time, money, and maximize loyalty points
New way to earn loyalty points (reviews, custom offers)
Ability to access all of this information from both a computer and a smart phone
Substitute for physical loyalty card, access to loyalty account details
Mobile Payments, with credit card/loyalty points
Overall sense of increased purchase security

### The Retailer & Supplier Interface

The present system can be configured to track user behavior leading up to including the sale, including what customers have “looked at” (scanned or added to their cart) it is the first system that can capture analytics along the entire purchase cycle in the offline world.

Similar to how e-commerce sites capture digital marketing analytics & website tracking, suppliers can be able to track impressions in the physical world. Historically, companies such as Dunnhumby have only been able to track purchase and retention data.

The system can also be configured to track how users rate the product after purchase as well as whether or not they re-purchase. The present system can be able to track every stage of the purchase cycle—from awareness to retention & evaluation.

Additionally, all of this data can be segmented using customer demographic & address-based information along each stage of the purchase cycle. By a segment of the supplier's choosing, they could see all of what consumers considered, what they purchased/didn't purchase, whether or not they re-purchased, along with average review scores from this audience, all comparable to average results. Such data could produce certain findings, such as “There is strong interest in the product from males aged 20-30 but very few are purchasing; they over-index on interest but under-index on sales. Instead, they typically selected product X”.

Suppliers will be able to identify segments of non-converting prospects that suppliers otherwise would not have known were interested in their product. This data will allow marketers to uncover a multitude of other insights, such as being able to better forecast demand and prevent against costly stock-outs.

All of this data can be sold to suppliers, leveraged to better understand how to encourage conversion, and utilized to optimize marketing efforts. Additionally, retailers and suppliers will be able to monitor this data to see if their marketing efforts are moving the dial.

### Real-Time Data Access via Web Dashboard

Suppliers & Retailers can be given access to this data via a web-based system, customizable for every user, similar to how web analytics systems operate. This will make the data instantly accessible and allow marketers to query and segment their information by any variable that is tracked: date, store location, time, age, sex, postal code, customer segment, customer behavior (purchase, impression, etc), product, product category, customer number of engagements, etc. Almost any condition/question can be queried if the data is tracked

Unlike other loyalty data solutions, this system does not produce an inflexible report; retailers & suppliers will be able to track exactly what variables are important to them, save those reports and have them automatically updated with new data the next time they log in, and be able to access them real time results whenever they choose.

Just as online stores track the entire purchase cycle with real-time web analytics results, this approach brings the same data-centric approach to bricks and mortar retail stores. This dashboard will also provide the retailer with extensive controls over exactly what data can be viewed for each account, allowing them to limit the information that their suppliers can access. As such, the system can adapt to the retailer's strategy, and evolve with it.

The platform also doubles as a marketing channel. Not only will suppliers be able to identify new segments of prospects through data analysis, but they will be able to immediately leverage this information and market directly to these prospects, enabling true one to one marketing.

Directly from their web dashboard, similar to how online marketers bid on keywords and book web banners with Google, suppliers can be permitted to plan marketing campaigns, addressing any segment using whatever targeting criteria they choose, including consumer behaviors. As such, a supplier could exclude regular customers, so as not to waste their marketing dollars on acquiring new customers. Alternatively, they could put out Loyalty/Retention campaigns with special offers to exclusively to customers who do purchase their products.

Coupons, discounts, and loyalty point offers can be produced through the system and offered to all users, or simply to target audiences that are not purchasing a product.

Campaigns can be turned on and off instantly, set to start and finish after certain dates, and set to expire after budgets have been met, all via the web dashboard.

These advertising assets will run similar to how online assets function and priced, where marketers pay per impression, per click or per conversion, or all of the above. All of these different pricing models are possible through the system, and the selected model is simply at the retailer's discretion.

Similar to how Google has featured listings, suppliers/marketers will also be able to pay a premium to be moved to the top of a customer's list of suggested products for which they already would have been included, ensuring that the listing is relevant.

Additionally, just as Google's programs operate, if users are not clicking on these featured listings, the pricing for that supplier's placement will increase. As such, customer behavior will dictate what content is relevant, and non-relevant offers will be bid out of their placements.

Campaign performance variables will also be accessible in real time through the dashboard. As such, marketers will be able to instantly gauge the success of their campaign.

The web dashboard can also be configured to provide the retailer with the tools manage which suppliers can access the marketing platform, as well as control the rates charged in the system for any and all of the following elements:
Cost for campaign creation
Cost per conversion
Cost per impression
Cost for featured listings
Cost per click

Summary of Certain Benefits to Retailer:
Increased customer loyalty
Increased up-sell and cross-sell opportunities
New marketing channel and analytics yielding multiple potential monetization opportunities with suppliers
Revenue from access to data marketing channel
Revenue from conversion, ad impressions, featured positions
New layers of data for marketing optimization

Summary of Certain Benefits to Supplier:
Instant access to customer buying behavior data across entire purchase cycle, by segment
Data set can be analyzed directly by the supplier, using whatever variables they choose
Tool for deploying a single offer to multiple retail locations in either discounts or loyalty points
New marketing platform to leverage data, directly reach either highly targeted groups or mass audience

While specific embodiments of the invention have been described and illustrated, such embodiments should be considered illustrative of the invention only and not as limiting the invention as construed in accordance with the accompanying claims.

1. A system for generating recommendations, the system comprising:
first and second client machines;
a connection router connected to the first and second client machines;
at least one database for storing the product information associated with a plurality of products, account information associated with a first account profile, and account information associated with a second account profile;
at least one server connected to the connection router and in communication with the at least one database, the at least one server operably configured to:
receive the product information from the at least one database;
generate a plurality of weighted values for each product based on the product information;
receive the account information associated with the first account profile;
select a set of products from the plurality of products based on the account information associated with the first account profile;
receive at least one survey result from the second client machine;
assign a matching value to a product from the set of products wherein the matching value is based on the plurality of weighted values and the at least one survey result;
generate a subset of products wherein the matching value of each product in the subset of products falls within a first predetermined range of values;
assign a similarity coefficient between the first account profile and the second account profile;
receive at least one recommendation associated with the second account profile from the at least one database if the similarity coefficient is within a second predetermined range of values; and
provide a list of recommendations to the first client machine, the list of recommendations comprising:
the at least one recommendation associated with the second account if the similarity coefficient is within the second predetermined range of values; and
the subset of products.

2. The system of claim 1, wherein the at least one server is further configured to:
identify conflicting products based on the account information; and
exclude the conflicting products from the set of products.

3. The system of claim 2, wherein the at least one server is operably configured to identify the conflicting products based on an objective metric.

4. The system of claim 3, wherein the objective metric is associated with a presence of an ingredient.

5. The system of claim 1, wherein the at least one server is operably configured to select the set of products from the plurality of products based on a purchase history of the first account profile.

6. The system of claim 1, wherein the at least one server is further configured to:
change the matching value based on input received from the first client machine; and
store the changed matching value in the product information.

7. The system of claim 1, wherein the first predetermined range is open and greater than a matching threshold.

8. The system of claim 1, wherein the second predetermined range is open and greater than a similarity threshold.

9. The system of claim 1, wherein the at least one server is operably configured to assign a similarity coefficient by calculating a Jaccard similarity coefficient based on the account information of the first account profile and the account information of the second account profile.

10. A method for generating a recommendation at a server, the method comprising:
receiving product information associated with a plurality of products, the product information being stored in at least one database;
generating a plurality of weighted values for each product based on the product information;
receiving account information associated with a first account profile stored in the at least one database;
selecting a set of products from the plurality of products based on the account information associated with a first account profile;
receiving at least one survey result from a client machine;
assigning a matching value to a product from the set of products wherein the matching value is based on the plurality of weighted values and the at least one survey result;
generating a subset of products wherein the matching value of each product in the subset of products falls within a first predetermined range of values;
assigning a similarity coefficient between the first account and a second account;
receiving at least one recommendation associated with the second account profile if the similarity coefficient is within a second predetermined range of values; and
providing a list of recommendations, the list of recommendations comprising:
the at least one recommendation associated with the second account if the similarity coefficient is within the second predetermined range of values; and
the subset of products.

11. The method of claim 10, further comprising identifying conflicting products based on the account information, wherein the set of products excludes the conflicting products.

12. The method of claim 11, wherein identifying the conflicting products comprises identifying based on an objective metric.

13. The method of claim 12, wherein the objective metric is associated with a presence of an ingredient.

14. The method of claim 10, wherein selecting the set of products comprises selecting the set of products from the plurality of products based on a purchase history of the first account profile.

15. The method of claim 10, further comprising:
changing the matching value based on input received from the client machine; and
storing the changed matching value in the product information.

16. The method of claim 10, wherein the first predetermined range is open and greater than a matching threshold.

17. The method of claim 10, wherein the second predetermined range is open and greater than a similarity threshold.

18. The method of claim 10, wherein assigning a similarity coefficient comprises calculating a Jaccard similarity coefficient based on the account information of the first account profile and account information of the second account profile.
